(19) United States
(12) Patent Application Publication
(10) Pub. No.: US 2006/0033792 A1
(43) Pub. Date: Feb. 16, 2006

(54) Printing method, printing apparatus, and printing system

(75) Inventor: Tsuyoshi Sano, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/201,151

(22) Filed: Aug. 11, 2005

(30) Foreign Application Priority Data
Aug. 11, 2004 (JP) 2004-234537
Sep. 7, 2004 (JP) 2004-259717
Aug. 2, 2005 (JP) 2005-224619
Aug. 2, 2005 (JP) 2005-224620

(51) Int. Cl. B41J 2/17

(52) U.S. Cl. 347/95; 347/16

(57) ABSTRACT

The present printing method includes the steps of: (A) when a first pigment ink that contains a moisturizing agent and a second pigment ink that contains more moisturizing agent than the first pigment ink have been ejected from a head in a state where a medium is present in a print region, receiving in a receiving section the first pigment ink and the second pigment ink that do not land on the medium; and (B) causing the head to eject the second pigment ink to the receiving section in a state where the medium is not present in the print region. With this printing method, the buildup of ink that lands outside the medium can be inhibited.

### CROSS-REFERENCE TO RELATED APPLICATIONS

The present application claims priority upon Japanese Patent Application No. 2004-234537 filed on Aug. 11, 2004, Japanese Patent Application No. 2004-259717 filed on Sep. 7, 2004, and Japanese Patent Application No. 2005-224619 and Japanese Patent Application No. 2005-224620 filed on Aug. 2, 2005, which are herein incorporated by reference.

### BACKGROUND OF THE INVENTION

1. Field of the Invention

The present invention relates to printing methods, printing apparatuses, and printing systems.

2. Description of the Related Art

Inkjet printers are known as one type of printing apparatus for ejecting liquid toward a medium to print thereon (see JP 2002-225311A). Inkjet printers print by ejecting ink as the liquid onto a medium such as paper. In recent years, such inkjet printers have come to be provided with a printing function of discharging ink up to the very edge of the medium, and receiving the ink that missed the medium using an ink receiving section that is provided with an absorbing member.

This type of printing has the following problem, however. That is, the ink that is ejected may have low permeability or may solidify easily. When such ink misses the medium and lands on the absorbing member of the ink receiving section, it may not permeate into the absorbing member well and remain as it is on the absorbing member. When the ink builds up in this way it gradually forms a mound on the absorbing member, and ultimately may dirty the medium that is printed.

### SUMMARY OF THE INVENTION

The present invention was arrived at in light of these issues, and it attempts to inhibit piling-up of ink that has missed the medium.

A first main aspect of the invention for achieving the above object is a printing method including the steps of:
when a first pigment ink that contains a moisturizing agent and a second pigment ink that contains more moisturizing agent than the first pigment ink have been ejected from a head in a state where a medium is present in a print region, receiving in a receiving section the first pigment ink and the second pigment ink that do not land on the medium; and
causing the head to eject the second pigment ink to the receiving section in a state where the medium is not present in the print region.

A second main aspect of the invention for achieving the above object is a printing method including the steps of:
receiving in a receiving section a pigment ink that does not land on a medium when the pigment ink has been ejected from a head in a state where the medium is present in a print region; and
causing the head to eject a pigment ink to the receiving section in a state where the medium is not present in the print region.

A third main aspect of the invention for achieving the above object is a printing method including the steps of:
ejecting, in a state where a medium is present in a print region, a first pigment ink that contains a moisturizing agent, and a second pigment ink that contains more moisturizing agent than the first pigment ink according to an image to be printed;
receiving in a receiving section the first pigment ink and the second pigment ink that do not land on the medium; and
ejecting, in a state where the medium is present in the print region, the second pigment ink to an adjacent region that is adjacent to and outside of a region where the receiving section receives the first pigment ink and the second pigment ink that have been ejected according to the image to be printed and that do not land on the medium.

A fourth main aspect of the invention for achieving the above object is a printing method including the steps of:
ejecting a pigment ink according to an image to be printed in a state where a medium is present in a print region;
receiving in a receiving section the pigment ink that does not land on the medium; and
ejecting, in a state where the medium is present in the print region, a pigment ink to an adjacent region that is adjacent to and outside of a region where the receiving section receives the pigment ink that has been ejected according to the image to be printed and that does not land on the medium.

Features of the present invention other than the above will be made clear through the present specification with reference to the accompanying drawings.

### BRIEF DESCRIPTION OF THE DRAWINGS

FIG. 1 is an explanatory diagram that shows an external configuration of a printing system.

FIG. 2 is a block diagram of an overall configuration of a computer 110 and a printer 1.

FIG. 3 is a schematic view of an overall configuration of the printer 1.

FIG. 4 is a transverse cross-section of the overall configuration of the printer 1.

FIG. 5 is an explanatory diagram showing an arrangement of nozzles.

FIG. 6 is an explanatory diagram for describing compositions of inks.

FIG. 7 is an explanatory diagram for describing an ink ejection range when borderless printing is performed.

FIG. 8A is an explanatory diagram of how ink is ejected during borderless printing. FIG. 8B is an explanatory diagram of how ink lands during borderless printing.

FIG. 9 is an explanatory diagram of a state where dark ink has landed on the sponge.

FIG. 10 is an explanatory diagram of a state where light ink has landed on the sponge.

FIG. 11 is an explanatory diagram for describing printing method 1 of a first embodiment.

FIG. 12A is an explanatory diagram for describing a positional relationship between a paper S and a platen during printing. FIG. 12B is an explanatory diagram for describing an ejection spillover region.

FIG. 13 is an explanatory diagram for describing printing method 2 of the first embodiment.

FIG. 14A is an explanatory diagram of how ink is ejected during borderless printing. FIG. 14B is an explanatory diagram of how ink lands during borderless printing.

FIG. 15 is an explanatory diagram of a state where light ink has landed in an adjacent region.

FIG. 16 is an explanatory diagram for describing printing method 1 of a second embodiment.

FIG. 17A is an explanatory diagram for describing a positional relationship between a paper S and a platen during printing. FIG. 17B is an explanatory diagram for describing an ejection spillover region.

FIG. 18A is an explanatory diagram of print data that are sent from a printer driver. FIG. 18B is an explanatory diagram of print data to which a printer-side controller 60 has added data for moisturization.

FIG. 19A is an explanatory diagram of how ink is ejected during borderless printing. FIG. 19B is an explanatory diagram of how ink lands during borderless printing.

### DESCRIPTION OF PREFERRED EMBODIMENTS

===Summary of the Disclosure===

At least the following matters will be made clear by the explanation in the present specification and the description of the accompanying drawings.

A printing method includes the steps of:
when a first pigment ink that contains a moisturizing agent and a second pigment ink that contains more moisturizing agent than the first pigment ink have been ejected from a head in a state where a medium is present in a print region, receiving in a receiving section the first pigment ink and the second pigment ink that do not land on the medium; and
causing the head to eject the second pigment ink to the receiving section in a state where the medium is not present in the print region.

With this printing method, it is possible to inhibit the buildup of ink that lands outside the medium.

Further, it is preferable that the receiving section has an absorbing member that absorbs the first pigment ink and the second pigment ink. With this printing method, the first pigment ink and the second pigment ink can be absorbed by the absorbing member.

Further, it is preferable that the receiving section receives the first pigment ink and the second pigment ink that do not land on a lateral end portion of the medium. With this printing method, it is possible to form an image up to the lateral end portions of the medium without leaving a margin.

Further, it is preferable that the receiving section receives the first pigment ink and the second pigment ink that do not land on upper and lower end portions of the medium. With this printing method, it is possible to form an image up to the upper and lower end portions of the medium without leaving a margin.

Further, it is preferable that by causing the head to eject the second pigment ink to the receiving section before printing on the medium, the head is caused to eject the second pigment ink to the receiving section in a state where the medium is not present in the print region. With this printing method, the absorbing member is wetted in advance, and thus a mound of ink can be prevented from building up on the absorbing member.

Further, it is preferable that by causing the head to eject the second pigment ink to the receiving section after printing on the medium, the head is caused to eject the second pigment ink to the receiving section in a state where the medium is not present in the print region. With this printing method, the absorbing member can be wetted, and thus a mound of ink can be prevented from building up on the absorbing member.

Further, it is preferable that whether or not to cause the head to eject the second pigment ink to the receiving section in a state where the medium is not present in the print region is determined based on a setting that has been made by a user. With this printing method, the user can perform a setting so that the second pigment ink is not ejected to the receiving section, in order to conserve the amount of second pigment ink that is consumed.

Further, it is preferable that in a case where printing is not to be performed on an end portion of the medium, the head is not caused to eject the second pigment ink to the receiving section in a state where the medium is not present in the print region. With this printing method, it is possible to conserve the amount of second pigment ink that is consumed.

Further, it is preferable that the first pigment ink and the second pigment ink both absorb light of a same wavelength, but absorb different amounts of the light. In this way, graininess in the printed image can be improved.

A printing apparatus includes:
a head that ejects a first pigment ink that contains a moisturizing agent and a second pigment ink that contains more moisturizing agent than the first pigment ink;
a receiving section that receives the first pigment ink and the second pigment ink that do not land on a medium when the first pigment ink and the second pigment ink have been ejected from the head in a state where the medium is present in a print region; and
a controller that causes the head to eject the second pigment ink to the receiving section in a state where the medium is not present in the print region.

With this printing apparatus, it is possible to inhibit the buildup of ink that lands outside the medium.

A printing system includes:
a computer; and
a printing apparatus that is connected to the computer, the printing apparatus having:
   a head that ejects a first pigment ink that contains a moisturizing agent and a second pigment ink that contains more moisturizing agent than the first pigment ink;
   a receiving section that receives the first pigment ink and the second pigment ink that do not land on a medium when the first pigment ink and the second pigment ink have been ejected from the head in a state where the medium is present in a print region; and
   a controller that causes the head to eject the second pigment ink to the receiving section in a state where the medium is not present in the print region.

With this printing system, it is possible to inhibit the buildup of ink that lands outside the medium.

A printing method includes the steps of:
receiving in a receiving section a pigment ink that does not land on a medium when the pigment ink has been ejected from a head in a state where the medium is present in a print region; and
causing the head to eject a pigment ink to the receiving section in a state where the medium is not present in the print region.

With this printing method, it is possible to inhibit the buildup of ink that lands outside the medium.

Further, it is preferable that an amount of the pigment ink that is ejected from the head to the receiving section in a state where the medium is not present in the print region is greater than an amount of the pigment ink that is ejected from the head to the receiving section in a state where the medium is present in the print region. With this printing method, the ink that is actively ejected to the receiving section can be inhibited from building up.

Further, it is preferable that the type of the pigment ink that is ejected from the head to the receiving section in a state where the medium is not present in the print region is included in the types of the pigment ink that are ejected from the head to the receiving section in a state where the medium is present in the print region. However, the type of the pigment ink that is ejected from the head to the receiving section in a state where the medium is not present in the print region may be different from the type of the pigment ink that is ejected from the head to the receiving section in a state where the medium is present in the print region.

A printing apparatus includes:
a head that ejects pigment ink;
a receiving section that receives the pigment ink that does not land on a medium when the pigment ink is ejected from the head in a state where the medium is present in a print region; and
a controller that causes the head to eject the pigment ink to the receiving section in a state where the medium is not present in the print region.

With this printing apparatus, it is possible to inhibit the buildup of ink that lands outside the medium.

A printing system includes:
a computer; and
a printing apparatus that is connected to the computer, the printing apparatus having:
   a head that ejects pigment ink;
   a receiving section that receives the pigment ink that does not land on a medium when the pigment ink is ejected from the head in a state where the medium is present in a print region; and
   a controller that causes the head to eject the pigment ink to the receiving section in a state where the medium is not present in the print region.

With this printing system, it is possible to inhibit the buildup of ink that lands outside the medium.

A printing method includes the steps of:
ejecting, in a state where a medium is present in a print region, a first pigment ink that contains a moisturizing agent, and a second pigment ink that contains more moisturizing agent than the first pigment ink according to an image to be printed;
receiving in a receiving section the first pigment ink and the second pigment ink that do not land on the medium; and
ejecting, in a state where the medium is present in the print region, the second pigment ink to an adjacent region that is adjacent to and outside of a region where the receiving section receives the first pigment ink and the second pigment ink that have been ejected according to the image to be printed and that do not land on the medium.

With this printing method, it is possible to inhibit the buildup of ink that lands outside the medium.

Further, it is preferable that the receiving section has an absorbing member that absorbs the first pigment ink and the second pigment ink. Thus, the first pigment ink and the second pigment ink can be absorbed by the absorbing member, and therefore the buildup of ink can be inhibited.

Further, it is preferable that the moisturizing agent of the second pigment ink that has been ejected to the adjacent region permeates beneath the region where the receiving section receives the first pigment ink and the second pigment ink that do not land on the medium. The pigment component thus permeates into the absorbing member, allowing the buildup of ink to be inhibited.

Further, it is preferable that the adjacent region is separated from the region where the receiving section receives the first pigment ink and the second pigment ink that do not land on the medium. Alternatively, it is preferable that the adjacent region partially overlaps the region where the receiving section receives the first pigment ink and the second pigment ink that do not land on the medium. The pigment component permeates further into the absorbing member.

Further, it is preferable that the receiving section receives the first pigment ink and the second pigment ink that do not land on a lateral end portion of the medium. As a result, it is possible to form an image up to the lateral end portions of the medium without leaving a margin. Further, it is preferable that the receiving section receives the first pigment ink and the second pigment ink that do not land on upper and lower end portions of the medium. As a result, it is possible to form an image up to the upper and lower end portions of the medium without leaving a margin.

Further, it is preferable that the head can move in a predetermined direction; and the second pigment ink is ejected from the head to the adjacent region after movement of the head has started but before the head ejects, while moving, the first pigment ink and the second pigment ink according to the image to be printed. The receiving section thus can be wetted with the moisturizing agent in advance.

Further, it is preferable that the head can move in a predetermined direction; and the second pigment ink is ejected from the head to the adjacent region after the head has ejected, while moving, the first pigment ink and the second pigment ink according to the image to be printed but before movement of the head is stopped. The receiving section thus can be wetted with the moisturizing agent immediately after ink has landed in the ejection spillover region.

Further, it is preferable that whether or not to cause an ejection of the second pigment ink to the adjacent region is determined based on a setting that has been made by a user. By doing this, it becomes possible for the user to conserve the amount of second pigment ink that is consumed.

Further, it is preferable that the controller does not cause an ejection of the second pigment ink to the adjacent region in a case where printing is not to be performed on an end portion of the medium. By doing this, it is possible to conserve the amount of second pigment ink that is consumed.

Further, the first pigment ink and the second pigment ink both absorb light of a same wavelength, but absorb different amounts of the light. It is therefore possible to improve graininess in the printed image.

A printing apparatus includes:
a head that ejects a first pigment ink that contains a moisturizing agent and a second pigment ink that contains more moisturizing agent than the first pigment ink;
a receiving section that, when the first pigment ink and the second pigment ink have been ejected from the head in a state where a medium is present in a print region, receives the first pigment ink and the second pigment ink that do not land on the medium; and
a controller that causes the head to eject, in a state where the medium is present in the print region, the second pigment ink to an adjacent region that is adjacent to and outside of a region where the receiving section receives the first pigment ink and the second pigment ink that have been ejected according to an image to be printed and that do not land on the medium.

With this printing apparatus, it is possible to inhibit the buildup of ink that lands outside the medium.

A printing system includes:
a computer; and
a printing apparatus that is connected to the computer, the printing apparatus having:
   a head that ejects a first pigment ink that contains a moisturizing agent and a second pigment ink that contains more moisturizing agent than the first pigment ink;
   a receiving section that, when the first pigment ink and the second pigment ink have been ejected from the head in a state where a medium is present in a print region, receives the first pigment ink and the second pigment ink that do not land on the medium; and
   a controller that causes the head to eject, in a state where the medium is present in the print region, the second pigment ink to an adjacent region that is adjacent to and outside of a region where the receiving section receives the first pigment ink and the second pigment ink that have been ejected according to an image to be printed and that do not land on the medium.

With this printing system, it is possible to inhibit the buildup of ink that lands outside the medium.

A printing method includes the steps of:
ejecting a pigment ink according to an image to be printed in a state where a medium is present in a print region;
receiving in a receiving section the pigment ink that does not land on the medium; and
ejecting, in a state where the medium is present in the print region, a pigment ink to an adjacent region that is adjacent to and outside of a region where the receiving section receives the pigment ink that has been ejected according to the image to be printed and that does not land on the medium.

With this printing method, it is possible to inhibit the buildup of ink that lands outside the medium.

Further, it is preferable that an amount of the pigment ink that is ejected to the adjacent region is greater than an amount of the pigment ink that is ejected to the region where the receiving section receives the pigment ink that has been ejected according to the image to be printed and that does not land on the medium. With this printing method, the ink that is actively ejected to the receiving section can be inhibited from building up.

Further, it is preferable that the type of the pigment ink that is ejected to the adjacent region is included in the types of the pigment ink that are ejected according to the image to be printed. However, the type of the pigment ink that is ejected to the adjacent region may be different from the type of the pigment ink that is ejected according to the image to be printed.

A printing apparatus includes:
a head that ejects a pigment ink;
a receiving section that receives the pigment ink that does not land on a medium when the pigment ink has been ejected from the head in a state where the medium is present in a print region; and
a controller that causes the head to eject, in a state where the medium is present in the print region, a pigment ink to an adjacent region that is adjacent to and outside of a region where the receiving section receives the pigment ink that has been ejected according to an image to be printed and that does not land on the medium.

With this printing apparatus, it is possible to inhibit the buildup of ink that lands outside the medium.

A printing system includes:
a computer; and
a printing apparatus that is connected to the computer, the printing apparatus having:
   a head that ejects a pigment ink;
   a receiving section that receives the pigment ink that does not land on a medium when the pigment ink has been ejected from the head in a state where the medium is present in a print region; and
   a controller that causes the head to eject, in a state where the medium is present in the print region, a pigment ink to an adjacent region that is adjacent to and outside of a region where the receiving section receives the pigment ink that has been ejected according to an image to be printed and that does not land on the medium.

With this printing system, it is possible to inhibit the buildup of ink that lands outside the medium.

===Configuration of Printing System===

An embodiment of a printing system is described next with reference to the drawings. However, the description of the following embodiment also encompasses implementations pertaining to a computer program and a storage medium storing the computer program, for example.

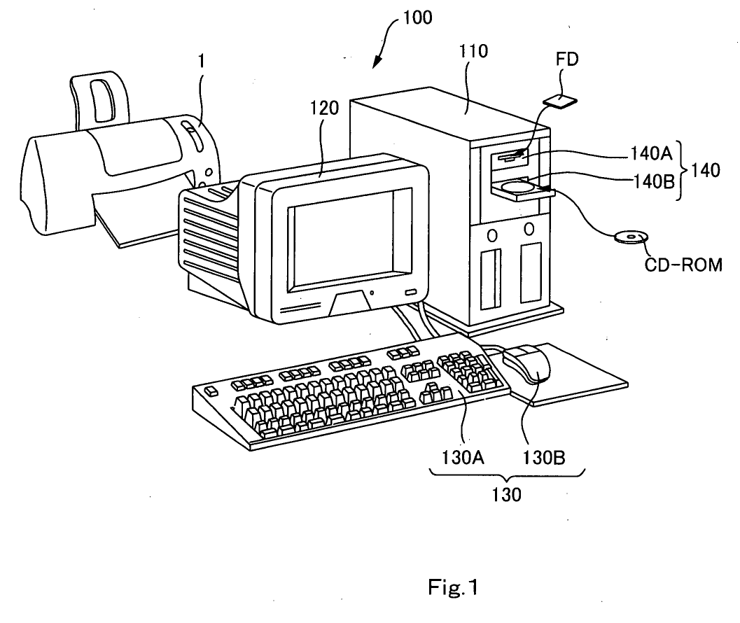

FIG. 1 is an explanatory diagram showing an external structure of a printing system. The printing system 100 is provided with a printer 1 and a computer 110. The printer 1 is a printing apparatus for printing images on a medium such as paper, cloth, or film. The computer 110 is communicably connected to the printer 1, and outputs print data that correspond to an image to be printed to the printer 1 so that the printer 1 can print that image. The computer 110 controls the printer 1 through the print data, and thus also is a print-control apparatus.

The printing system 100 is also provided with a display device 120, an input device 130, and a record/play device 140. The display device 120 has a display, and displays the user interface of the printer driver, for example. The input device 130 is for example a keyboard 130A and a mouse 130B, and is used to operate an application program or adjust the settings of the printer driver, for example, through the user interface that is displayed on the display device 120. The record/play device 140 is for example a flexible disk drive device 140A or a CD-ROM drive device 140B.

A printer driver is installed on the computer 110. The printer driver is a program for achieving the function of displaying the user interface on the display device 120, as well as the function of converting image data that have been output from the application program into print data. The printer driver is stored on a storage medium (computer-readable storage medium) such as a flexible disk FD or a CD-ROM. The printer driver also can be downloaded onto the computer 110 via the Internet. It should be noted that this program is made of codes for achieving various functions.

===Configuration of Printer and Computer===

<Regarding the Configuration of the Printer and the Computer>

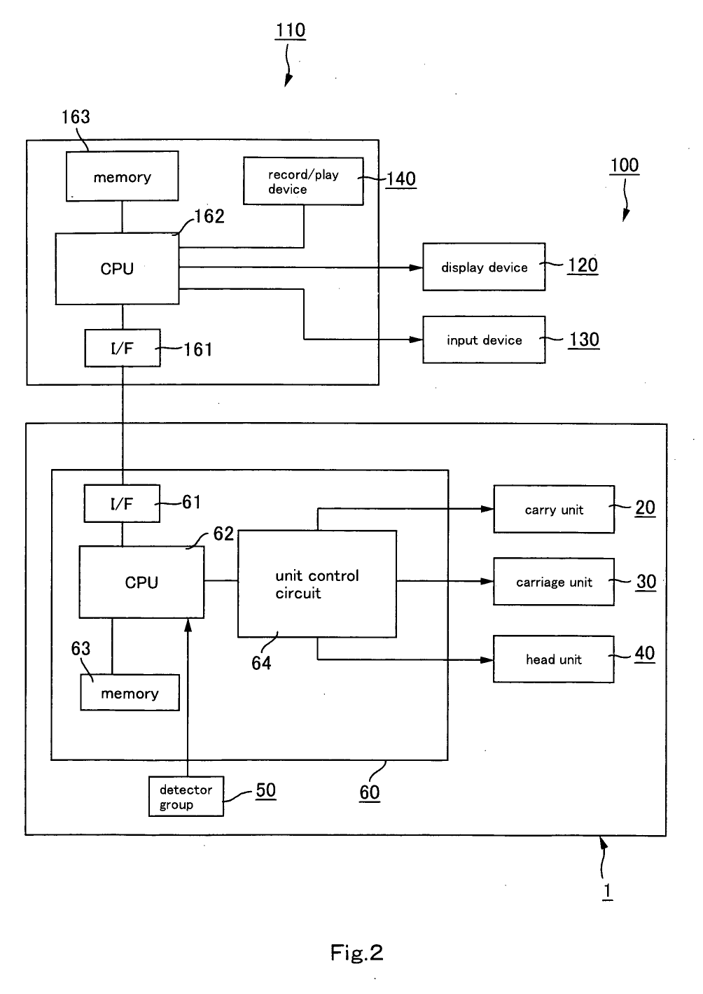

FIG. 2 is a block diagram for describing an overall configuration of the computer 110 and the printer 1.

The computer 110 has an interface section 161, a CPU 162, and a computer-side memory 163. The interface section 161 is for sending and receiving data between the printer 1, which is an external device, and the computer 110. The CPU 162 is a computation processing device for performing the overall control of the computer 110. The computer-side memory 163 is a memory element for securing a working area and an area for storing programs such as the printer driver. The CPU 162 creates print data from the image data according to the printer driver that is stored on the computer-side memory 163, and sends the print data to the printer 1. By installing the printer driver on the computer 110, the CPU 162 and the computer-side memory 163 together constitute a computer-side controller that controls the printer 1 through the print data.

The printer 1 has a carry unit 20, a carriage unit 30, a head unit 40, a detector group 50, and a printer-side controller 60. The printer 1 receives print signals from the computer 110, which is an external device, and through the printer-side controller 60 controls the various units (the carry unit 20, the carriage unit 30, and the head unit 40). The printer-side controller 60 controls those units based on the print data received from the computer 110 to print an image on the paper. The detector group 50 monitors the conditions within the printer 1, and outputs the result of this detection to the printer-side controller 60. The printer-side controller 60 controls the units based on the detection results that it receives from the detector group 50.

The printer-side controller 60 is a control unit for performing control of the printer. The printer-side controller 60 has an interface section 61, a CPU 62, a printer-side memory 63, and a unit control circuit 64. The interface section 61 is for sending and receiving data between the computer 110, which is an external device, and the printer 1. The CPU 62 is a computation processing device for performing the overall control of the printer. The printer-side memory 63 is for securing a working area and an area for storing the programs of the CPU 62, for example, and has memory means such as a RAM or EEPROM. The CPU 62 controls the units through the unit control circuit 64 in accordance with the program that is stored on the printer-side memory 63.

It should be noted that the computer-side controller (CPU 162 and the computer-side memory 163) and the printer-side controller 60 together function as a controller that controls the overall printing system. The printer driver that is stored on the computer-side memory 163 causes the computer 110 to create print data and send those print data to the printer 1. On the other hand, the program that is stored on the printer-side memory 63 causes the carry unit 20 to carry the paper, causes the carriage unit 30 to move the carriage, and causes the head unit 40 to eject ink, according to the print data. Thus, the printer driver and the program on the printer can be considered programs that work in concert to cause the printing system to perform printing.

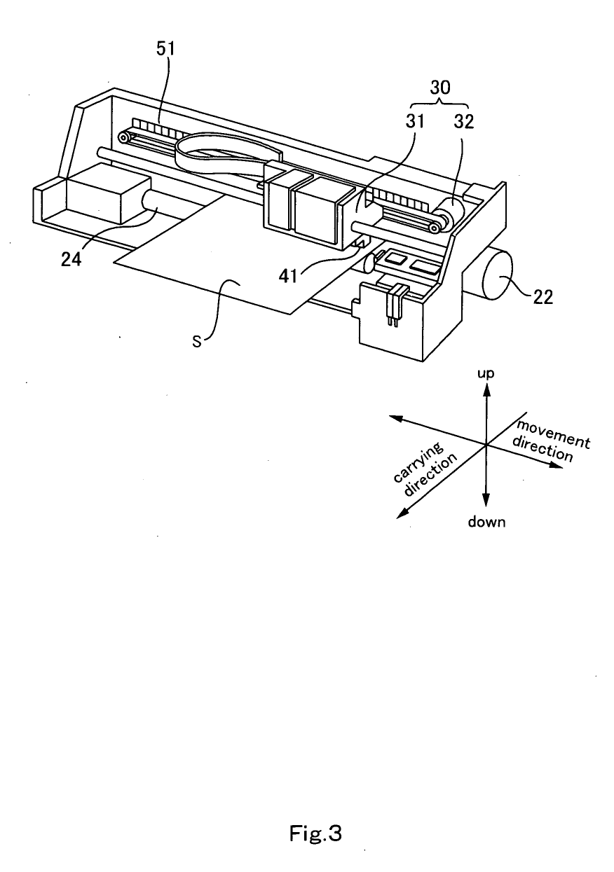

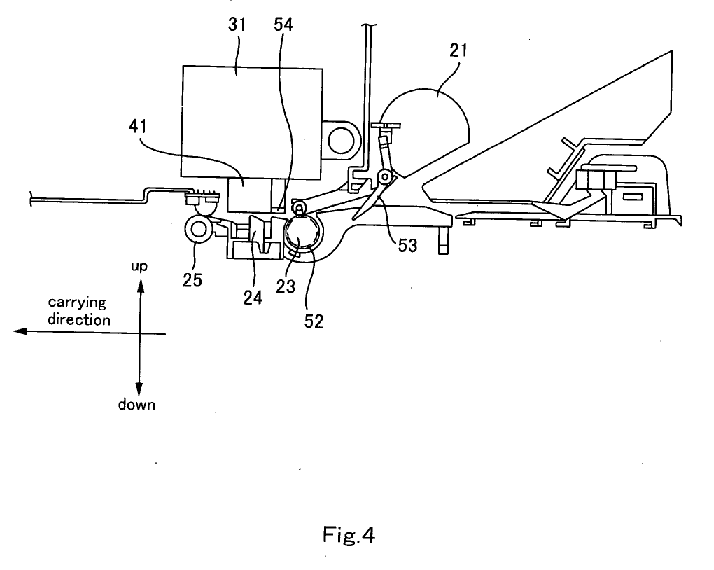

FIG. 3 is a diagram that schematically shows the overall configuration of the printer 1. FIG. 4 is a horizontal sectional view showing the overall structure of the printer 1. The basic structure of the printer according to the present embodiment is described below.

The carry unit 20 is for feeding a medium (for example, paper S) up to a printable position and carrying the paper in a predetermined direction (hereinafter, referred to as the carrying direction) by a predetermined carry amount during printing. That is, the carry unit 20 is a carrying section for carrying the paper. The carry unit 20 has a paper feed roller 21, a carry motor 22 (hereinafter, referred to as PF motor), a carry roller 23, a platen 24, and a paper discharge roller 25. However, in it not absolutely necessary that the carry unit 20 have all of these structural elements in order for it to function as a carrying section. The paper feed roller 21 is a roller for feeding, into the printer, paper that has been inserted into a paper insert opening. The paper feed roller 21 has a cross-sectional shape in the shape of the letter D, and the length of its circumference section is set longer than the carrying distance to the carry roller 23, so that the paper can be carried up to the carry roller 23 using its circumference section. The carry motor 22 is a motor for carrying the paper in the carrying direction, and is constituted by a DC motor, for example. The carry roller 23 is a roller for carrying the paper S that has been fed by the paper feed roller 21 up to a printable region, and is driven by the carry motor 22. The platen 24 supports the paper S being printed. The paper discharge roller 25 is a roller for discharging the paper S to outside the printer, and is provided on the carrying direction downstream side of the printable region. The paper discharge roller 25 is rotated in synchronization with the carry roller 23.

The carriage unit 30 is for making the head move (also referred to as “scan”) in a predetermined direction (hereinafter, referred to as the “movement direction”). The carriage unit 30 has a carriage 31 and a carriage motor 32 (also referred to as “CR motor”). The carriage 31 can be moved back and forth in the movement direction. (Thus, the head is moved in the movement direction.) The carriage 31 detachably holds an ink cartridge that contains ink. The carriage motor 32 is a motor for moving the carriage 31 in the movement direction, and for example is constituted by a DC motor. The carriage motor 32 becomes the movement section for moving the head (discussed later) in the movement direction.

The head unit 40 is for ejecting ink onto the paper. The head unit 40 has a head 41. The head 41 has a plurality of nozzles and intermittently ejects ink from those nozzles. The head 41 is provided in the carriage 31. Thus, when the carriage 31 moves in the movement direction, the head 41 also moves in the movement direction. Dot lines (raster lines) are formed on the paper in the movement direction due to the head 41 intermittently ejecting ink while moving in the movement direction.

The detector group 50 includes a linear encoder 51, a rotary encoder 52, a paper detection sensor 53, and an optical sensor 54, for example. The linear encoder 51 is for detecting the position of the carriage 31 in the movement direction. The rotary encoder 52 is for detecting the amount of rotation of the carry roller 23. The paper detection sensor 53 is for detecting the position of the front end of the paper to be printed. The paper detection sensor 53 is provided at a position where it can detect the position of the front end of the paper as the paper is being fed toward the carry roller 23 by the paper feed roller 21. It should be noted that the paper detection sensor 53 is a mechanical sensor that detects the front end of the paper through a mechanical mechanism. More specifically, the paper detection sensor 53 has a lever that can be rotated in the carrying direction, and this lever is disposed such that it protrudes' into the path over which the paper is carried. In this way, the front end of the paper comes into contact with the lever and the lever is rotated, and thus the paper detection sensor 53 detects the position of the front end of the paper by detecting the movement of the lever. The optical sensor 54 is attached to the carriage 31. The optical sensor 54 detects whether or not the paper is present through its light-receiving section detecting the reflected light of the light that has been irradiated onto the paper from its light-emitting section. The optical sensor 54 can also detect the width of the paper by detecting the position of the end portions of the paper while being moved by the carriage 31. Depending on the circumstances, the optical sensor 54 can also detect the front end of the paper (the end portion on the carrying direction downstream side; also called the upper end) and the rear end of the paper (the end portion on the carrying direction upstream side; also called the lower end). The optical sensor 54 detects the end portions of the paper optically, and thus has higher detection accuracy than the mechanical paper detection sensor 53.

<Regarding the Nozzles>

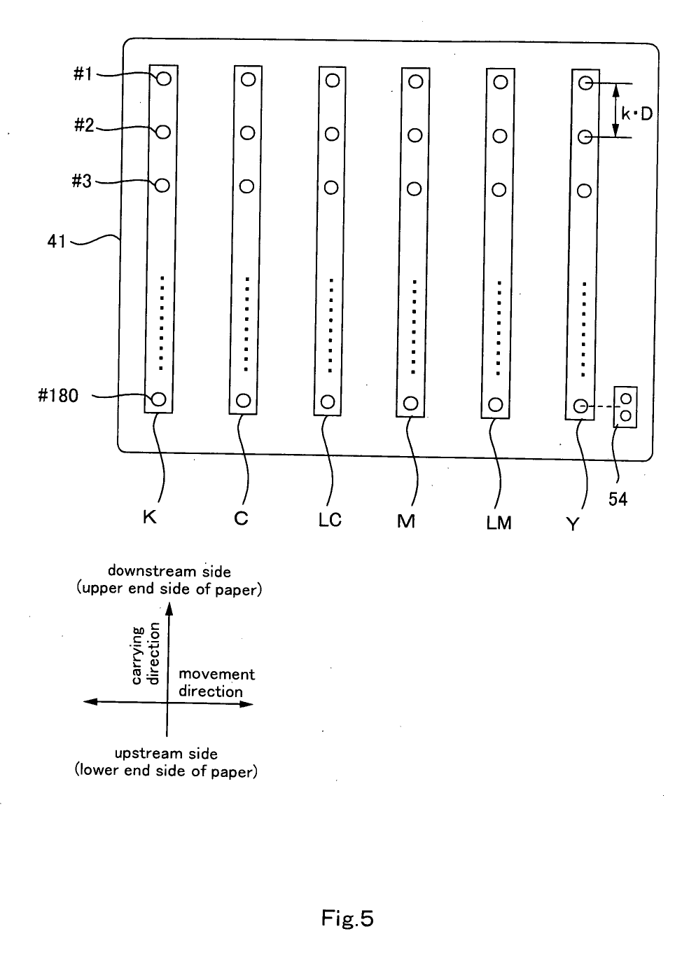

FIG. 5 is an explanatory diagram showing the arrangement of the nozzles in the lower surface of the head 41. Six nozzle groups are formed in the lower surface of the head 41. Each nozzle group is provided with a plurality of nozzles (in this embodiment, 180), which are ejection openings for ejecting the various color inks.

The plurality of nozzles in each nozzle group are arranged in a row at aconstant spacing (nozzle pitch: k·D) in the carrying direction. Here D is the minimum dot pitch in the carrying direction (that is, the spacing at the maximum resolution of dots that are formed on the paper S). Also, k is an integer of 1 or more.

The nozzles of the nozzle groups are assigned a smaller number (#1 to #180) the more downstream in the carrying direction they are located. It should be noted that position of the optical sensor 54 mentioned above in the carrying direction is substantially the same as the position of nozzle #180, which is the most upstream nozzle.

Each nozzle is provided with an ink chamber (not shown) and a piezo element. Driving the piezo element causes the ink chamber to expand and contract, thereby ejecting an ink droplet from the nozzle.

It should be mentioned here that when inkjet printers form a print image on paper, they form the print image using numerous dots. Inkjet printers express gradation in the print image by changing the density of the dots on the paper. For example, dark areas in the print image have a high dot density and light areas in the print image have a low dot density.

Light areas in the print image tend to appear grainy. For example, when printing a light pale blue using only cyan ink, the cyan ink dots are formed sparsely, and this leads to a printed image that is more of a cyan polka-dot pattern than a light pale blue (grainy feel).

Accordingly, the head 41 of this embodiment is provided with a light cyan ink nozzle group LC and a light magenta ink nozzle group LM in addition to a black ink nozzle group K, a cyan ink nozzle group C, a magenta ink nozzle group M, and a yellow ink nozzle group Y.

The light cyan ink is lighter in darkness than the cyan ink (dark ink). Cyan has the property of absorbing red light, its complementary color, and light cyan dots (light dots) that are formed by light cyan ink absorb a smaller amount of red light than the dots that are formed by cyan ink (dark dots).

The light magenta ink is lighter in darkness than the magenta ink (dark ink). Magenta has the property of absorbing green light, its complementary color, and dots that are formed by light magenta ink (light dots) absorb a smaller amount of green light than the dots that are formed by magenta ink (dark dots).

Accordingly, in this embodiment, light pale blue images are printed by forming light cyan dots on the paper using light cyan ink. This allows the grainy feel in the image to be reduced because the use of light cyan ink to express a light pale blue requires a greater number of dots than if only cyan ink were used.

It should be noted that yellow has little effect on the darkness and thus light ink thereof is not prepared. However, the use of dark yellow ink (dark ink) allows deep yellow colors to be expressed on the printed image. It should be noted that yellow has the property of absorbing blue light, which is a complementary color, and dark yellow dots (dark dots) that are formed by dark yellow ink absorb a greater amount of blue light than dots that are formed by yellow ink (light dots).

<Regarding the Composition of the Ink>

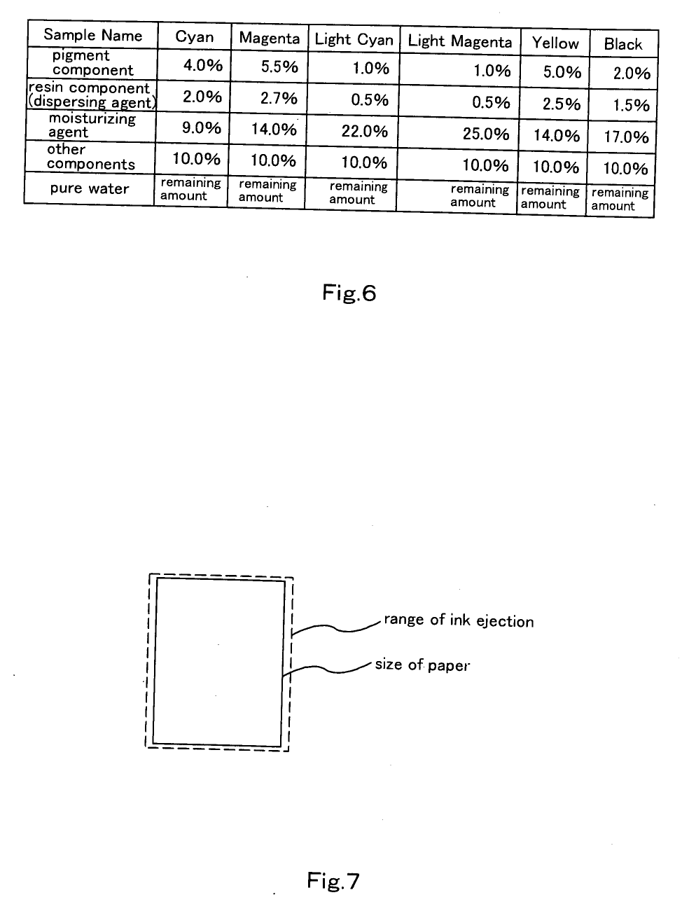

The composition of the inks is described here with reference to FIG. 6. The inks are composed of a pigment component, a resin component, a moisturizing agent, other components, and pure water.

The pigment component is the coloring agent. With dye ink the coloring agent is dissolved in the solvent, but with pigment inks the pigment component is dispersed within a liquid. When pigment ink lands on paper, the coloring agent stops on the surface of the paper and very little of it permeates into the paper. In this way, the coloring agent, that is, the pigment component, has the function of bringing color to the surface of the paper. For that reason, dark color inks have a high proportion of pigment component and light color inks have a low proportion of pigment component. For example, the coloring agent “color index pigment blue 15:3” is used for cyan, and this pigment component proportion is 4.0% in cyan ink but only 1.0% in light cyan ink. Thus light cyan ink contains less pigment component than cyan ink. Similarly, the pigment component proportion of magenta ink is 5.5% but only 1.0% for light magenta ink, and thus light magenta ink contains less pigment component than magenta ink.

The resin component is “resin,” for example. The resin component coats the pigment component to prevent aggregation of the dispersed pigment component. The resin component thus functions as a dispersing agent. Because the resin component coats the pigment component, the resin component increases as the pigment component increases and decreases as the pigment component decreases. For example, the resin component is 2.0% for cyan ink whereas the resin component is 0.5% for light cyan ink, and thus light cyan ink has a smaller amount of resin component than cyan ink. The same applies for magenta and light magenta.

The moisturizing agent is a multivalent alcohol such as “glycerin”. The moisturizing agent has the function of preventing evaporation of the water in the ink. The moisturizing agent keeps the ink from solidifying within the nozzles by preventing the evaporation of the water in the ink in the nozzles, thereby preventing clogging in the nozzles. It should be noted that the inks include other components such as surface-active agents, as well as pure water.

The manner in which the viscosity of the inks is adjusted is discussed next. The ink viscosity is affected by the amount of solid component (primarily the pigment component and the resin component) and moisturizing agent in the ink. For example, the ink becomes more viscous as the amount of solid component and moisturizing agent increases, and becomes less viscous as the amount of solid component and moisturizing agent decreases. It is preferable that the various color inks have an equivalent viscosity. This is because if the viscosities of the various color inks are different, the amount of ink that is ejected from the nozzles also will differ. The ink viscosity is thus adjusted by reducing the amount of moisturizing agent if the amount of solid component is large, and increasing the amount of moisturizing agent if the amount of solid component is small.

Here, the amount of moisturizing agent in cyan ink and light ink is examined. Light cyan ink is a lighter ink than cyan ink. Light cyan ink therefore has a smaller amount of pigment component than cyan ink, and thus its solid component (pigment component and resin component) is smaller. On the other hand, it is necessary to adjust the viscosity of the light cyan ink to the same degree of viscosity as the cyan ink. To do this, the amount of moisturizing agent that the light cyan ink contains is adjusted so that the light cyan ink contains more moisturizing agent than the cyan ink. It should be noted that for the same reason, light magenta ink contains more moisturizing agent than magenta ink.

Light cyan ink has less solid component and more moisturizing agent than cyan ink, and thus is less prone to solidify due to evaporation of its water component. Similarly, light magenta ink has less solid component and more moisturizing agent than magenta ink, and thus is less prone to solidify due to evaporation of its water component.

===Borderless Printing===

<Regarding Borderless Printing>

Here, borderless printing is described. Borderless printing is a print mode in which the lateral end portions and the upper and lower end portions of the paper S are printed without leaving a margin. As shown in FIG. 7, when borderless printing is executed, ink is ejected from the nozzles to a range that is wider than the size of the paper S. Thus, even if the position of the paper is shifted during carrying, the entire surface of the paper can be printed without leaving a margin.

When borderless printing is executed, however, there is ink that is ejected outside of the paper. This ink does not land on the paper S and thus lands on the platen 24 that supports the paper S. It should be noted that the region to which ink that does not land on the paper S lands is referred to as the “ejection spillover region.”

When the ink that landed on the platen 24 during borderless printing adheres to the rear surface of the paper that is to be carried next, that paper will become dirty. Accordingly, the platen 24 of this printer for performing borderless printing has the structure described below.

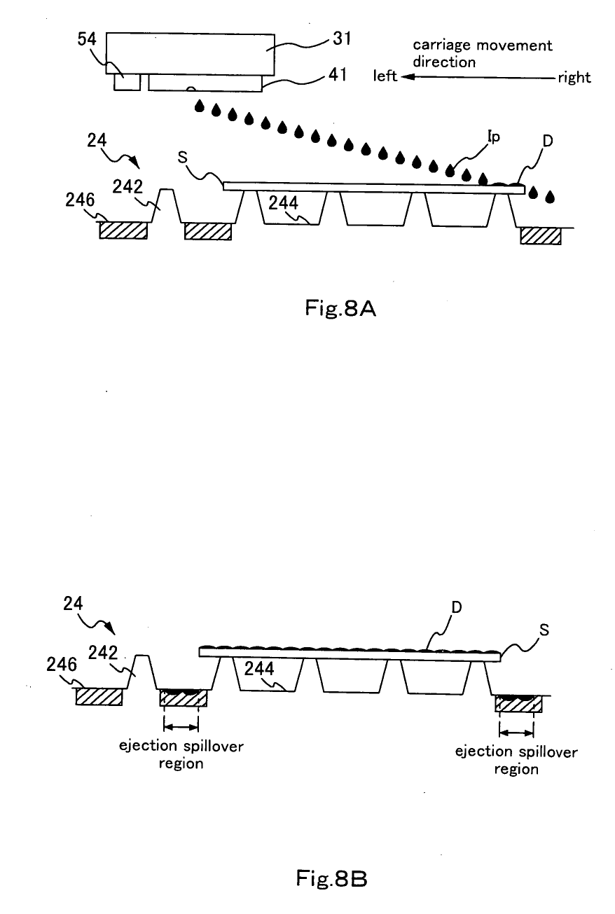

FIG. 8A is an explanatory diagram of how ink is ejected when borderless printing is performed. FIG. 8B is an explanatory diagram of how ink lands when borderless printing is performed. As shown in FIG. 8A, the platen 24 has a support section 242 for supporting the paper S, and a groove section 244 that is provided at a position that is lower than the support section.

When borderless printing is performed, the nozzles provided in the head 41 eject ink over a range that is wider than the paper S. The ink that does not land on the paper S instead lands in the groove section 244. However, since the groove section 244 is located lower than the support section 242, the ink that lands in the groove section is at a lower position than the support section 242. This allows the ink that has landed in the groove section 244 to be kept from adhering to the rear surface of the paper.

It should be noted that the groove section 244 is pre-designed so that the ejection spillover region is located on the groove section 244 (in FIG. 8B, the ejection spillover region is the region where ink lands in the groove section 244). The groove section 244 thus serves as a receiving section for receiving the ink that does not land on the paper S when borderless printing is executed.

When a large amount of ink lands in the groove section 244, that ink builds up in the groove section 244 and forms a mound of solidified ink in the groove section 244. When this mound of ink reaches the height of the support section 242, there is a risk that it will cause the rear surface of the paper S to become dirty. In order to prevent this, a sponge 246 that serves as an absorbing member for absorbing ink is provided in the area of the groove section 244 that becomes the ejection spillover region.

<Regarding Buildup of the Pigment ink>

The sponge is made of thin fibers woven into a mesh and has excellent porosity and absorptivity. However, the coloring agent in pigment ink is not dissolved like in dye ink, and easily builds up on the sponge 246.

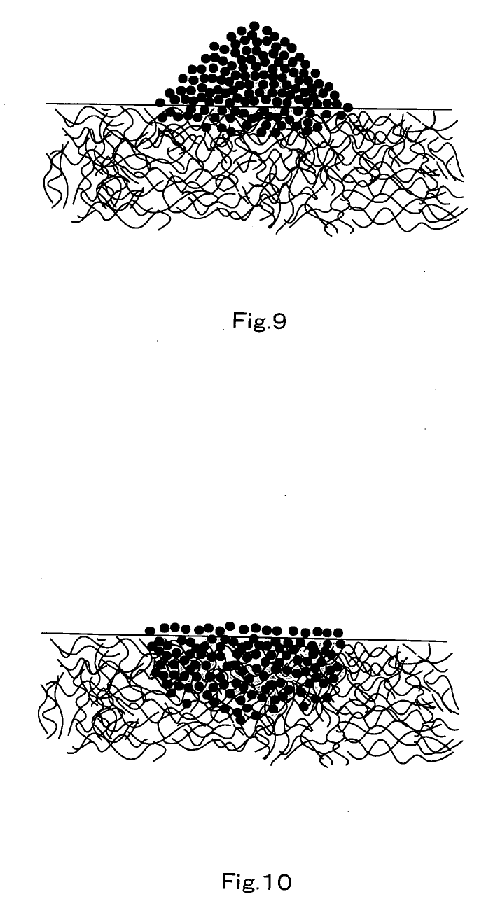

FIG. 9 is an explanatory diagram of a state where dark ink has landed on the sponge 246. FIG. 10 is an explanatory diagram of a state where light ink has landed on the sponge 246.

Dark ink (such as cyan ink) has less moisturizing agent than light ink (such as light cyan ink). For that reason, when dark ink lands on the sponge 246, the moisturizing agent does not permeate deep into the sponge 246 and the sponge surface also becomes more prone to drying. The pigment component that lands on the sponge 246 thus does not permeate into the sponge 246 and becomes trapped in the fibers of the sponge surface. Additionally, because dark ink has a large amount of pigment component, when dark ink lands on the sponge 246 its pigment component is prone to remaining on the sponge surface.

When dark ink repeatedly lands on the sponge 246, its pigment component remains in the fibers of the sponge surface and fills up the mesh of fibers of the sponge surface. When this happens, the sponge 246 no longer functions as an absorbing member. The result is that ink easily builds up on the sponge, increasing the likelihood that the mound of ink will become high.

On the other hand, light ink (such as light cyan ink) has more moisturizing agent than dark ink (such as cyan ink). For this reason, when light ink has landed on the sponge 246, its moisturizing agent permeates deep into the sponge 246 over a wide range from the surface of the sponge 246. The moisturizing agent that has permeated into the sponge 246 stimulates flow of the pigment component in the ink that has landed on the sponge 24.6, and this leads to the pigment component permeating into the sponge 246. The end result is that less pigment remains on the sponge surface and thus the mesh of fibers of the sponge surface is less prone to becoming filled in by pigment. Additionally, light ink has a small amount of pigment component, and thus when light ink lands on the sponge 246 its pigment component is not likely to remain on the sponge surface.

Further, if moisturizing agent has permeated deep into the sponge 246, then even if dark ink lands on the sponge 246, the moisturizing agent will cause its pigment component to flow and permeate into the sponge 246. That is, the pigment component is less likely to remain on the sponge surface if the moisturizing agent has permeated deep into the sponge 246.

Even in a case where the pigment component has collected on the sponge surface, as long as the mesh of fibers of the sponge surface has not yet become filled, the moisturizing agent of light ink will permeate into the interior of the sponge when a large amount of light ink lands on the sponge and will cause permeation, into the sponge, of the pigment component that has built up on the sponge surface. That is, the pigment component is less likely to build up on the sponge surface also when light ink is made to land on the sponge 246 after dark ink has already landed on the sponge 246.

===(1) Printing Method 1 of the First Embodiment===

Accordingly, in the first embodiment, light ink is actively ejected to the sponge 246 to cause the moisturizing agent to permeate into the interior of the sponge and thereby inhibit ink from building up on the sponge 246.

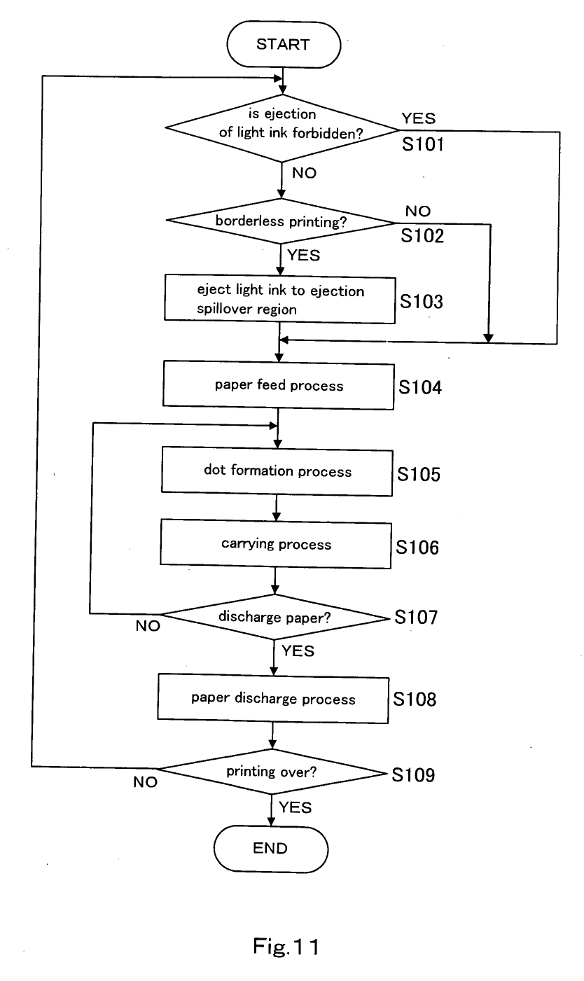

Next, the printing method 1 of the first embodiment is described with reference to FIG. 11. This printing method is executed by the printer-side controller 60 controlling the units within the printer according to the program that is stored on the memory 63. It should be noted that in the following description, light cyan ink is the light ink that is actively ejected to the sponge 246. However, it is also possible to use light magenta ink in place of light cyan ink or to use to light cyan ink and light magenta ink together.

In step S101, the printer-side controller 60 determines whether or not the user has forbid the ejection of light cyan ink. In the initial settings this forbid setting is off, and thus here the determination is NO.

In step S102, the printer-side controller 60 determines whether or not the print mode is “borderless printing.” The user sets whether to perform borderless printing through the printer driver when he performs the command to execute printing, and thus the determination made by the printer-side controller 60 is based on this setting made by the user. Here, the determination is YES.

In step S103, the printer-side controller 60 causes the head 41 to eject light cyan ink to the ejection spillover region of the groove section 244.

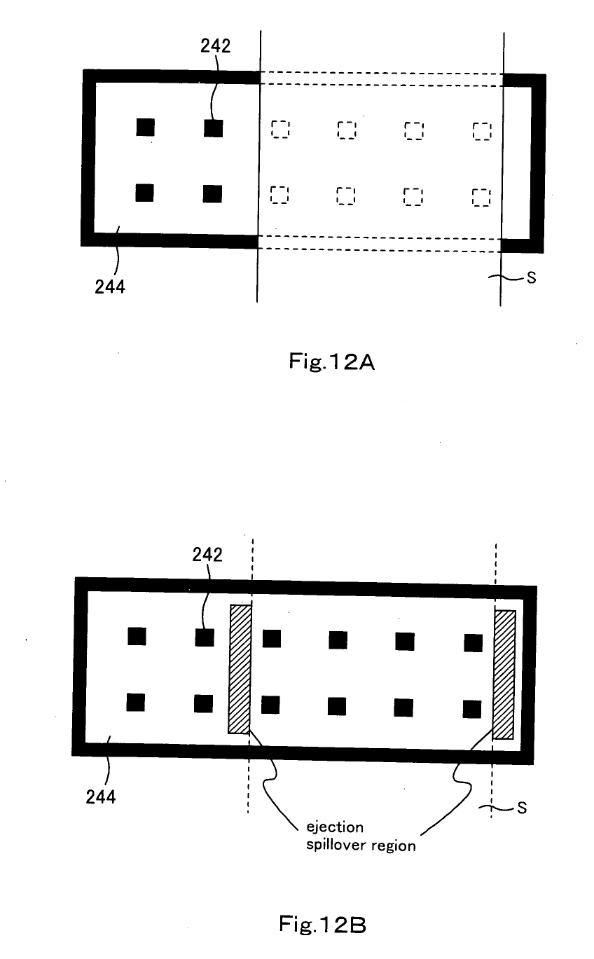

FIG. 12A and FIG. 12B are explanatory diagrams of the ejection spillover region. In the case of borderless printing on the paper S having the width shown in FIG. 12A, the shaded area shown in FIG. 12B becomes the ejection spillover region. Because the ejection spillover region differs depending on the width of the paper, the printer-side controller 60 chooses the location of the ejection spillover region in accordance with the width of the paper to be printed. It should be noted that the user sets the paper size (A4 size, for example) through the printer driver when he performs the command to execute printing, and thus the printer-side controller 60 determines the location of the ejection spillover region based on this setting.

The printer-side controller 60 then moves the carriage 31 so that the light cyan ink nozzle group is in opposition to the ejection spillover region and causes the head 41 to eject light cyan ink from the light cyan ink nozzle group. Due to this, light cyan ink is applied to the ejection spillover region, and the moisturizing agent permeates into the sponge 246 in the ejection spillover region.

It should be noted that with this printing method, the light cyan ink is actively ejected to the ejection spillover region before the paper feed process (S104). The paper thus is not in the print region at this time, and therefore the light cyan ink that has been ejected will not land on the paper.

In step S104, the printer-side controller 60 performs the paper feed process. The paper feed process is a process for supplying the paper to be printed into the printer and positioning it at a print start position (the so-called indexed position). The printer-side controller 60 rotates the paper feed roller 21 so as to feed the paper S to be printed up to the carry roller 23. The printer-side controller 60 then rotates the carry roller 23 so as to position the paper S that has been fed from the paper feed roller 21 at the print start position. When the paper S has been positioned at the print start position, the paper S is in a position where it can be in opposition to at least some of the nozzles of the head 41. That is, when the paper feed process has finished, the paper S has arrived at a printable position (print region).

In step S105, the printer-side controller 60 performs a dot formation process. The dot formation process is a process for intermittently ejecting ink from the head 41 that is moved in the movement direction in order to form dots on the paper S. The printer-side controller 60 drives the carriage motor 32 to move the carriage 31 in the movement direction. Then, while the carriage 31 is moving, the printer-side controller 60 causes ink to be ejected from the head based on the print data. Dots are formed on the paper S when ink droplets that have been ejected from the head land on the paper. It should be noted that the region to which ink is ejected from the head 41 during the dot formation process is the region called the “print region.”

As described in FIG. 8, in the dot formation process during borderless printing, the ink that does not land on the paper S lands on the sponge 246. However, light cyan ink has already been applied to the region in which the ink that does not land on the paper S lands (ejection spillover region) in step S103 and thus the moisturizing agent has permeated into the interior of the sponge 246. For this reason, even if dark ink (such as cyan ink or magenta ink) lands on the sponge 246 during the dot formation process in borderless printing, its pigment component permeates down into the sponge 246.

In step S106, the printer-side controller 60 performs a carrying process. The carrying process is a process for moving the paper S in the carrying direction relative to the head. The printer-side controller 60 drives the carry motor to rotate the carry roller and thereby carry the paper S in the carrying direction. As a result of the carrying process, it becomes possible for the head 41 to form dots at a position different from the position of the dots formed in the previous dot formation process.

In step S107, the printer-side controller 60 performs a determination of whether or not to discharge the paper S being printed. The paper is not discharged if there are still data for printing the paper S that is being printed. The procedure then returns to step S105 and the printer-side controller 60 alternately repeats the dot formation process and the carrying process until there are no longer any data for printing remaining, gradually printing an image made of dots on the paper S. Once there are no longer any data for printing the paper S being printed, the procedure is advanced to step S108.

In step S108, the printer-side controller 60 performs a paper discharge process. The printer-side controller 60 rotates the paper discharge roller to discharge the printed paper S to the outside. It should be noted that the determination of whether or not to discharge the paper can also be made based on a paper discharge command that is included in the print data.

In step S109, the printer-side controller 60 determines whether or not to continue printing. If a next sheet of paper is to be printed, then the procedure is returned to step S101. If a next sheet of paper is not to be printed, then the printing operation is ended.

In this embodiment, light cyan ink is actively ejected to the ejection spillover region in step S103 before the dot formation process (S105). As a result, even if the ink that does not land on the paper in the dot formation process (S105) when borderless printing is performed lands on the groove section 244, the pigment component of that ink will permeate into the sponge 246 and the ink will not build up on the sponge.

However, a user who prefers to curb ink consumption may not wish to eject ink that is not related to printing. In such a case, the user can perform a setting through the printer driver to forbid the ejection of light cyan ink etc. in step S103. If the user has performed this setting to forbid the ejection of light cyan ink, the printer-side-controller omits the processing of step S103 (YES in step S101) and then starts printing (step S104). As a result, although ink becomes more prone to build up on the sponge, it is possible to curb ink consumption. Further, even if ink builds up on the sponge, as long as the amount is small, the height of the mound of ink will be low and thus will not dirty the rear surface of the paper S.

If borderless printing is not performed, then ink will not land in the groove section 244. Performing the process of step S103 in this case as well will thus waste ink. For that reason, if in step S102 the printer-side controller 60 determines that the print mode is not “borderless printing,” then the printer-side controller 60 omits the process of step S103 (NO in step S102) and then starts printing (step S104).

===(1) Printing Method 2 of the First Embodiment===

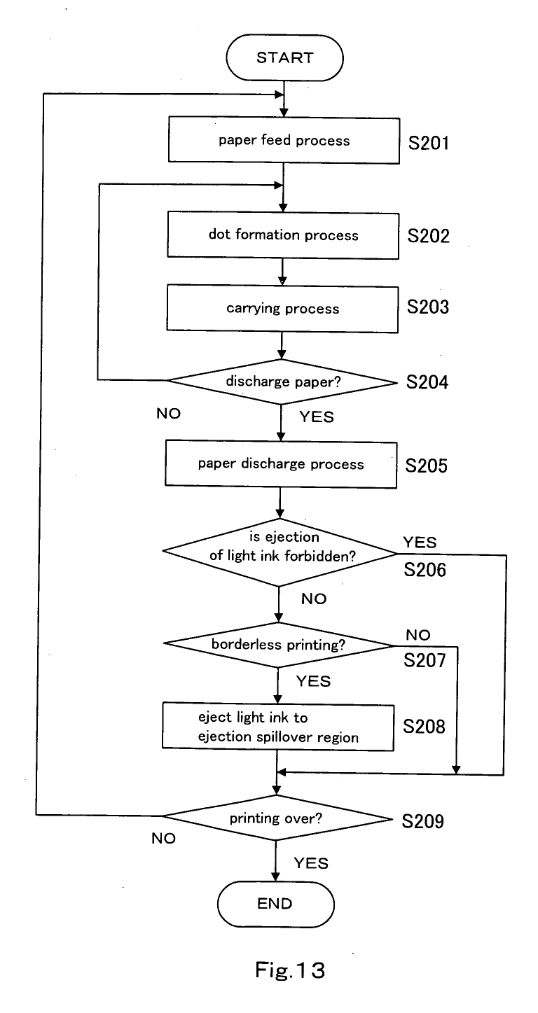

Next, a printing method 2 of the first embodiment is described with reference to FIG. 13.

In the previous method, light cyan ink is actively ejected to the ejection spillover region before the dot formation process. In this printing method, however, light cyan ink is actively ejected to the ejection spillover region after the dot formation process. The nature of the processing operations of this printing method is the same as in the printing method discussed above, and thus will not be described.

With this printing method, there is a possibility that the pigment component will remain on the sponge surface when the dot formation process (step S202) is performed. However, the amount of ink that lands on the sponge 246 during the printing of one sheet of paper (the ejection spillover amount) is small, and thus does not fill up the mesh of fibers of the sponge surface. Also, immediately after printing, the ink on the sponge surface has not yet dried. Since light cyan ink is actively ejected to the ejection spillover region when the sponge is in such a state (step S208), the pigment that has stopped on the sponge surface can be made to permeate into the sponge.

However, the approach of ejecting light cyan ink to the groove section 244 before printing is executed as in printing method 1 allows the groove section 244 to be moistened in advance, and thus can more effectively prevent the ink that lands on the groove section 244 from building up.

It should be noted that in this printing method, light cyan ink is actively ejected to the ejection spillover region (step S208) after the paper discharge process (S205). As a result, the paper is not present in the print region at the time of step S208, and thus the light cyan ink that is ejected will not land on the paper.

===(1) Printing Method 3 of the First Embodiment===

Borderless printing is primarily used to print photographic images on the paper. When printing photographic images, however, it is rare that dots are formed in all of the pixels, but instead the dots are formed dispersed (for example, dots are formed dispersed in light image portions such as the color of the sky). Consequently, a relatively small amount of ink lands in the ejection spillover region when borderless printing is performed. If only a small amount of ink lands on the sponge, however, then the surface area of the ink with respect to the ink amount becomes large, and this expedites the evaporation of water in the ink and makes the sponge surface more prone to drying. Because little ink lands in the ejection spillover region when borderless printing is performed, the ink that has landed on the sponge 246 is thus more prone to dry, and this discourages permeation of the pigment component into the interior of the sponge 246. The result is that, as shown in FIG. 9, the pigment component remains on the surface of the sponge 246 when borderless printing is performed. In particular, dark ink has a small amount of moisturizing agent and a large amount of pigment, and thus, when dark ink lands dispersed on the sponge 246, its water component evaporates easily and its pigment component therefore is more likely to remain on the sponge surface. It is for this reason that in the above printing methods an ink with a large amount of moisturizing agent (light cyan ink) is actively ejected to the ejection spillover region before or after the dot formation process (see S103 of FIG. 11, S208 of FIG. 13).

The type of ink that is actively ejected to the ejection spillover region is, however, not limited to ink that has a large amount of moisturizing agent, as in the foregoing printing methods. In other words, it follows that as long as the surface of the sponge 246 can be made less likely to dry, the pigment component will less likely remain on the sponge surface.

For example, it is also possible for the printer-side controller in S103 or S208 above to actively eject cyan ink, which is darker than light cyan ink, to the ejection spillover region. However, when the cyan ink that is ejected at this time lands dispersed in the ejection spillover region as when performing borderless printing, the build up of pigment will be more rather than less likely to occur. For this reason, if cyan ink is to be actively ejected in S103 or S208, then the printer-side controller will, at a minimum, eject more ink than the amount of ink that is ejected when borderless printing is performed so as to soak the surface of the sponge 246. By doing this, the surface area of the ink with respect to the ink amount becomes small, the sponge surface becomes less prone to drying even if cyan ink is used, and thus, the pigment component of the ink which has landed during borderless printing permeates down into the sponge 246 and makes it harder for the pigment component to remain on the sponge surface. It should be noted that a “large ink amount” means a large ink amount per unit time and unit area, in light of the object to make the sponge less prone to dry.

It should be noted that it is not necessary for the type of ink that is actively ejected to the ejection spillover region (the type of ink that is ejected to the sponge 246 in a state where paper is not present in the print region) to be included in the types of ink that are ejected when borderless printing is performed (the types of ink that are ejected to the sponge 246 in a state where paper is present in the print region). For example, black ink may be actively ejected to the ejection spillover region in cases where the type of ink that is ejected when performing borderless printing is limited to color inks except for black ink.

===(1) Other Implementations of the First Embodiment===

<(1) Regarding Borderless Printing>

In this embodiment, a case in which printing is performed in such a manner that a border is not left at the lateral end portions of the paper S was described as an example of borderless printing. However, because there are also ejection spillover regions when printing so that no border is left at the upper and lower end portions of the paper S, it is also possible to actively eject light cyan ink (or light magenta ink) to these regions as well. The following is a description of borderless printing of the upper end portion of the paper S (borderless printing of the lower end portion of the paper S is substantially the same as borderless printing of the upper end portion, and thus description thereof is omitted).

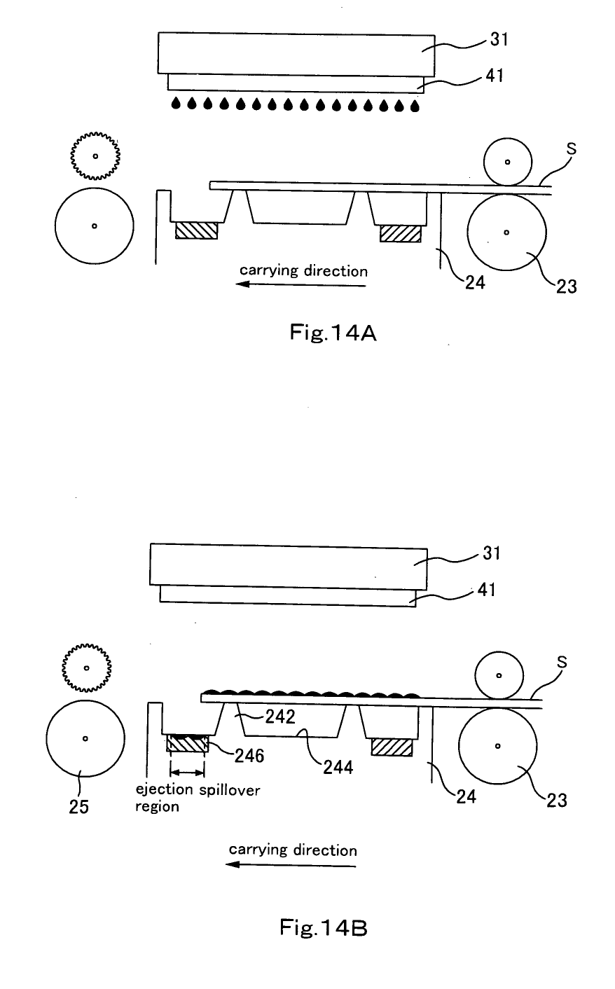

FIG. 14A is an explanatory diagram of how ink is ejected when performing borderless printing on the upper end portion of the paper. FIG. 14B is an explanatory diagram of how ink lands when performing borderless printing on the upper end portion of the paper.

When performing borderless printing on the upper end portion of the paper, ink is also ejected from nozzles that are not in opposition to the paper S, such that ink is ejected over a range that is wider than the paper S. For this reason, the ink that is ejected from nozzles that are not in opposition to the paper S (the nozzles on the carrying direction downstream side in the drawings) does not land on the paper S and instead lands on the sponge 246 of the groove section 244 (this region in which ink lands becomes the ejection spillover region).

Accordingly, by ejecting light cyan ink from the nozzles on the carrying direction downstream side before the paper feed process (S104) or after the paper discharge process (S205), light cyan ink can be ejected to the ejection spillover region when performing borderless printing on the upper end portion. Thus, the deposition of ink in the ejection spillover region when performing borderless printing on the upper end portion can be inhibited.

However, the amount of ejection spillover ink when performing borderless printing on the upper end portion of the paper is less than the amount of ejection spillover ink when performing borderless printing on the lateral end portions of the paper. Thus, it is also possible to actively eject light cyan ink to only the ejection spillover region of the lateral end portions of the paper and to not actively eject light cyan ink to the ejection spillover region of the upper and lower end portions of the paper.

===(2) Printing Method 1 of the Second Embodiment===

In the first embodiment discussed above, light ink is actively ejected to the ejection spillover region in order to prevent the buildup of ink. However, when light ink is ejected to the ejection spillover region in a state where the paper is present in the print region, there is a risk that the light ink will land on the paper if the paper has been carried in an offset manner. Accordingly, the approach of the second embodiment is to actively eject light ink to an adjacent region that is adjacent to and outside of the ejection spillover region.

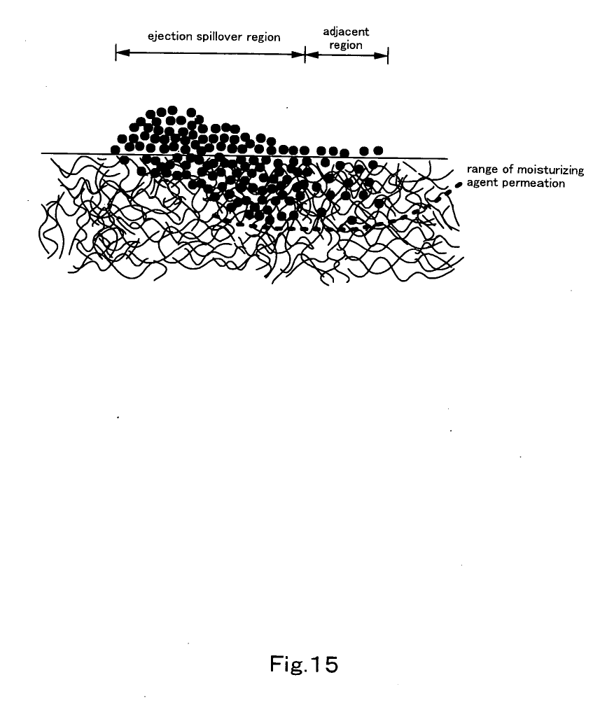

FIG. 15 is an explanatory diagram showing a state in which light ink has landed in the adjacent region. When light ink lands in the adjacent region, the moisturizing agent of the light ink permeates from the adjacent region side beneath the ejection spillover region. As a result, the pigment component of the ink that has landed in the ejection spillover region permeates down into the sponge. It is therefore possible to prevent the buildup of ink that has landed in the ejection spillover region.

<(2) Regarding the Process Flow>

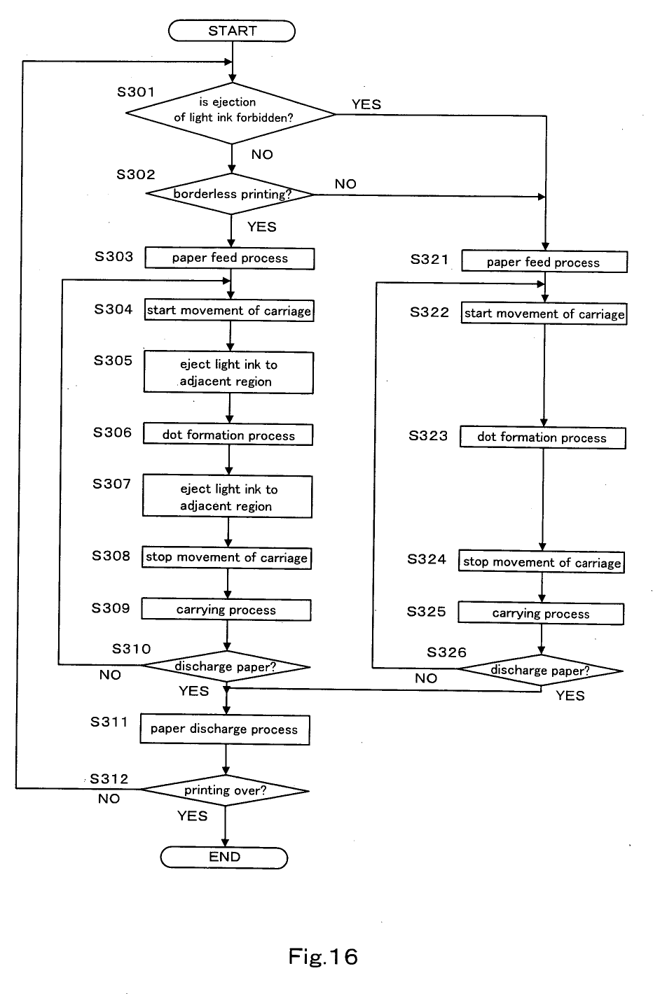

The printing method 1 of the second embodiment is described next with reference to FIG. 16. This printing method is executed by the printer-side controller 60 controlling the units within the printer according to the program stored on the memory 63. It should be noted that in the following description, light cyan ink is the light ink that is actively ejected to the sponge 246. However, it is also possible to use light magenta ink in place of light cyan ink or to use to light cyan ink and light magenta ink together.

In step S301, the printer-side controller 60 determines whether or not the user has forbid the ejection of light cyan ink. In the initial settings this forbid setting is off, and thus here the determination is NO.

In step S302, the printer-side controller 60 determines whether or not the print mode is “borderless printing.” The user sets whether to perform borderless printing through the printer driver when he performs the command to execute printing, and thus the determination made by the printer-side controller 60 is based on this setting made by the user. Here, the determination is YES.

In step S303, the printer-side controller 60 performs the paper feed process. The paper feed process is a process for supplying the paper to be printed into the printer and positioning it at a print start position (the so-called indexed position). The printer-side controller 60 rotates the paper feed roller 21 so as to carry the paper S to be printed up to the carry roller 23. The printer-side controller 60 then rotates the carry roller 23 to position the paper S that has been fed from the paper feed roller 21 at the print start position. When the paper S has been positioned at the print start position, the paper S is in a position where it can be in opposition to at least some of the nozzles of the head 41. That is, when the paper feed process has finished, the paper S has arrived at a printable position (print region).

In step S304, the printer-side controller 60 starts movement of the carriage 31. The printer-side controller 60 moves the carriage 31 by driving the carriage motor 32, thereby moving the head 41 toward the print region.

In step S305, the printer-side controller 60 causes the head 41 to eject light cyan ink to the adjacent region that is adjacent to and outside of the ejection spillover region.

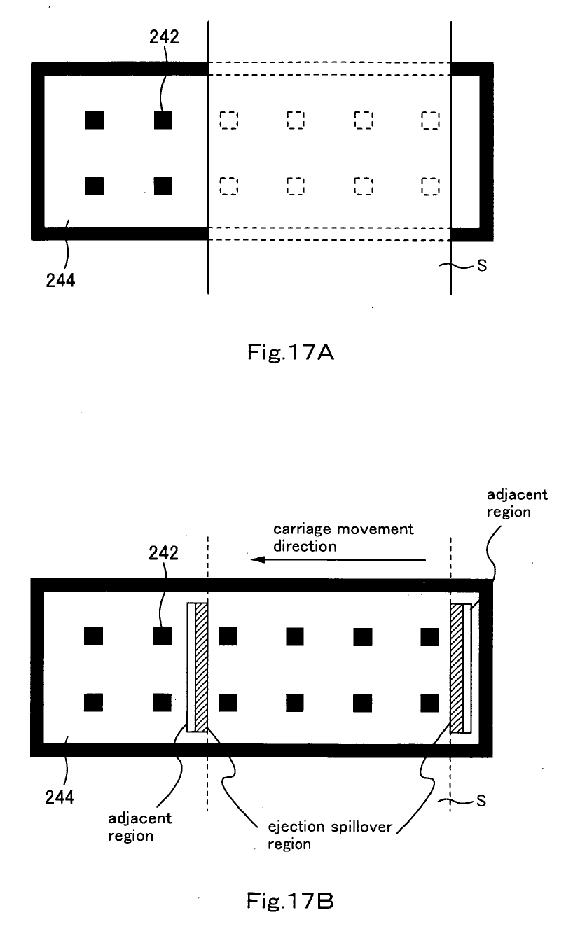

FIGS. 17A and 17B are explanatory diagrams of the ejection spillover region. If borderless printing is performed on the paper S having the width shown in FIG. 17A, then the shaded portion in FIG. 17B becomes the ejection spillover region. Then, if the carriage is moved from the right to the left in FIG. 17B, the region that is adjacent to the right of the right-side ejection spillover region in the drawing is the adjacent region in step S305. That is, the region that is adjacent, on the movement direction upstream side, to the ejection spillover region is the adjacent region. Since the ejection spillover region differs depending on the width of the paper, the position of the adjacent region is determined according to the width of the paper to be printed.

Then, when the light cyan ink nozzle group has arrived at a position where it can eject ink onto the adjacent region, the printer-side controller 60 causes the head 41 to eject light cyan ink from the light cyan ink nozzle group. By doing this, light cyan ink is applied to the adjacent region and the moisturizing agent permeates into the interior of the sponge 246 beneath the ejection spillover region.

In step S306, the printer-side controller 60 performs a dot formation process. The dot formation process is a process for intermittently ejecting ink from the head 41 that is moving in the movement direction in order to form dots on the paper S. Then, while the carriage 31 is moving, the printer-side controller 60 causes ink to be ejected from the head based on the print data. Dots are formed on the paper S when ink droplets that have been ejected from the head land on the paper. It should be noted that the region to which ink is ejected from the head 41 during the dot formation process is the region known as the “print region,” and is the region to which ink is ejected according to the image to be printed.

As described in FIG. 8B, in dot formation during borderless printing, the ink that does not land on the paper S lands on the sponge 246. However, the moisturizing agent of the light cyan ink that has been applied to the adjacent region in step S305 permeates into the sponge 246 below the region in which the ink that does not land on the paper S lands (ejection spillover region). For this reason, even if dark ink (such as cyan ink or magenta ink) lands on the sponge 246 during dot formation in borderless printing, its pigment component permeates down into the sponge 246.

In step S307, the printer-side controller 60 causes the head 41 to eject light cyan ink to the adjacent region that is adjacent to and outside of the ejection spillover region. If the carriage is moved from the right to the left in FIG. 17B, then the region that is adjacent on the left to the left-side ejection spillover region in the drawing is the adjacent region in step S307. That is, the region that is adjacent on the movement direction downstream side to the ejection spillover region is the adjacent region.

In step S308, the printer-side controller 60 stops driving the carriage motor 32, thereby stopping movement of the carriage 31.

In step S309, the printer-side controller 60 performs a carrying process. The carrying process is a process for moving the paper S in the carrying direction relative to the head. The printer-side controller 60 drives the carry motor to rotate the carry roller and thereby carry the paper S in the carrying direction. As a result of the carrying process, it becomes possible for the head 41 to form dots at a position different from the position of the dots formed in the previous dot formation process.

In step S310, the printer-side controller 60 performs a determination of whether or not to discharge the paper S being printed. The paper is not discharged if there still is data for printing the paper S that is being printed. In this case, the procedure then returns to step S304 and the printer-side controller 60 alternately repeats the dot formation process and the carrying process until there are no longer any data for printing, gradually printing an image made of dots on the paper S. Once there are no longer any data for printing on the paper S being printed, the procedure is advanced to step S311.

In step S311, the printer-side controller 60 performs a paper discharge process. The printer-side controller 60 causes rotation the paper discharge roller in order to discharge the printed paper to the outside. It should be noted that the determination of whether or not to discharge the paper can also be made based on a paper discharge command that is included in the print data.

In step S312, the printer-side controller 60 determines whether or not to continue printing. If a next sheet of paper is to be printed, then the procedure is returned to step S301. If a next sheet of paper is not to be printed, then the printing operation is ended.

In this embodiment, light cyan ink is actively ejected to the adjacent region in step S305 and step S307 before and after the dot formation process (S306). As a result, even if the ink that does not land on the paper during the dot formation process (S306) in borderless printing lands in the groove section 244, the pigment component of that ink will permeate into the sponge 246 and thus the ink will not build up on the sponge.

However, a user who prefers to curb ink consumption may not wish to eject ink that is unrelated to printing. In such a case, the user can perform a setting through the printer driver to forbid the ejection of light cyan ink etc. to the adjacent region. If the user has performed this setting to forbid the ejection of light cyan ink etc., then the printer-side controller, without performing an ejection of light cyan ink to the adjacent region, performs the paper feed process (S321), the start of carriage movement (S322), the dot formation process (S323), the stopping of carriage movement (S324), the carrying process (S325), and the paper discharge determination (S326) as discussed above. As a result, although ink becomes more prone to build up on the sponge, it is possible to curb ink consumption. Further, even if ink builds up on the sponge, as long as the amount is small, the height of the mound of ink will be low and thus the rear surface of the paper S will not become dirty.

If borderless printing is not performed, then ink will not land in the groove section 244. Thus, performing the processing of step S305 and step S307 in this case as well will waste ink. For that reason, if in step S302 the printer-side controller 60 determines that the print mode is not “borderless printing,” then the printer-side controller 60 carries out printing (step S321 through step S326) without performing an ejection of light cyan ink to the adjacent region.

<(2) Method of Ejecting Light Cyan Ink to the Adjacent Region>

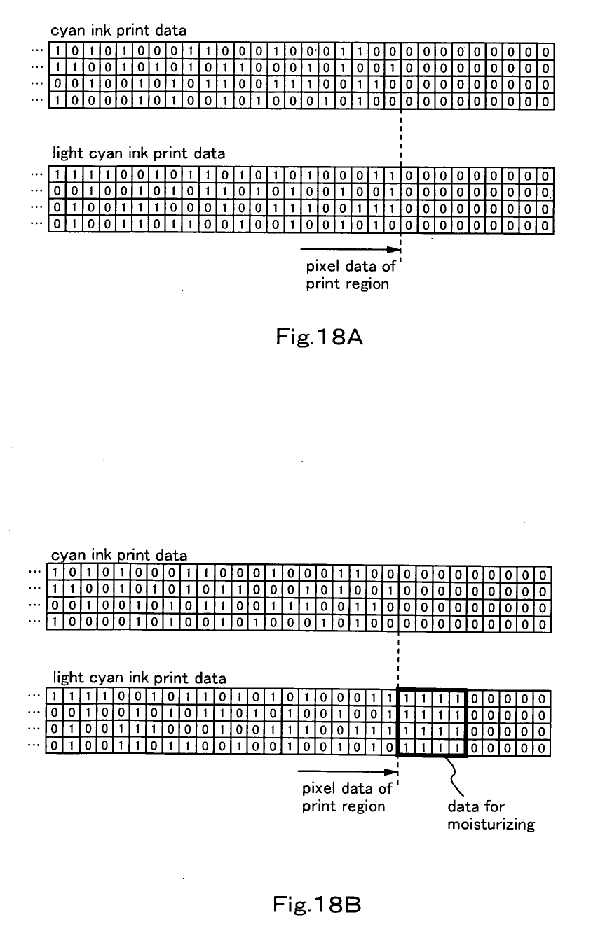

FIG. 18A is an explanatory diagram of the print data that are sent from the printer driver.

The print data are made of a plurality of pixel data. Each pixel data is associated with a pixel in the image to be printed. If the pixel data is “1”, then ink is ejected to the pixel corresponding to that pixel data, and the ink that is ejected forms a dot where it lands on the paper. If the pixel data is “0”, then ink is not ejected to the pixel corresponding to that image data. The printer-side controller 60 causes the ejection of ink from the nozzles based on each piece of pixel data so as to form dots that correspond to the image to be printed, thereby printing a print image made of innumerable dots on the medium.

In FIG. 18A, the pixel data corresponding to the pixels of the print region are either “1” or “0” depending on the image to be printed. On the other hand, the pixel data corresponding to the pixels that are outside the print region are “0” because ink is not ejected. In this regard, the print data for cyan ink and the print data for light cyan ink are the same.

FIG. 18B is an explanatory diagram of the print data when the printer-side controller 60 of the embodiment has added data for moisturization. In this embodiment, the printer-side controller 60 sets the pixels of a four by four pixel area adjacent to the pixels of the print region, in the print data for light cyan ink, to “1”. These pixel data become data for moisturization for wetting the ejection spillover region with moisturizing agent. It should be noted that the process of adding data for moisturization is not performed with respect to the print data for cyan ink.

When the printer-side controller 60 causes the ejection of ink based on the print data, light cyan ink is ejected to the pixels adjacent to the print region due to the data for moisturization. Normally, ink that has been ejected based on pixel data for end portions of the print region does not land on the paper and instead lands in the ejection spillover region, and thus light cyan ink that has been ejected due to the data for moisturization lands in the adjacent region that is adjacent to and outside of the ejection spillover region. The moisturizing agent of the light cyan ink that has been ejected due to the data for moisturization permeates beneath the ejection spillover region, and as discussed already, inhibits the buildup of ink.

In this embodiment, the printer-side controller 60 adds data for moisturization to the print data that are sent from the printer driver. However, it is also possible for the printer driver to create print data to which data for moisturization have been added and for the print data to be sent from the computer to the printer. In this case, light cyan ink can be ejected to the adjacent region as long as the printer-side controller 60 executes printing according to the print data, without the printer-side controller 60 determining the print region.

===(2) Printing Method 2 of the Second Embodiment===

Borderless printing is primarily used to print photographic images on paper. When printing photographic images, however, it is rare that dots are formed in all of the pixels, and instead they are formed dispersed (for example, dots are formed dispersed in light image portions such as the color of the sky). Consequently, a relatively small amount of ink lands in the ejection spillover region when borderless printing is performed. If little ink lands on the sponge, however, then the surface area of the ink with respect to the ink amount becomes large, and this expedites the evaporation of water in the ink and makes the sponge surface more prone to drying. Thus, because a small amount of ink lands in the ejection spillover region when borderless printing is performed, the ink that has landed on the sponge 246 is more prone to dry, and this discourages permeation of the pigment component into the interior of the sponge 246. The result is that, as shown in FIG. 9, the pigment component remains on the surface of the sponge 246 when borderless printing is performed. In particular, dark ink has a small amount of moisturizing agent and a large amount of pigment, and thus when dark ink lands dispersed on the sponge 246, the water component of the ink evaporates easily and its pigment component therefore is likely to remain on the sponge surface. It is for this reason that in the above printing method an ink with a large amount of moisturizing agent (light cyan ink) is ejected to the adjacent region (see S305 and S307 of FIG. 16).

The type of ink that is actively ejected to the adjacent region is, however, not limited to ink that has a large amount of moisturizing agent, as in the foregoing printing method. In other words, it follows that as long as the surface of the sponge 246 can be made less likely to dry, the pigment component will less likely remain on the sponge surface.

For example, it is also possible for the printer-side controller in S305 or S307 above to actively eject cyan ink, which is darker than light cyan ink, to the adjacent region. However, when the cyan ink that is ejected at this time lands dispersed in the ejection spillover region as when borderless printing is performed, the build up of pigment will be more rather than less likely to occur. For this reason, if cyan ink is to be actively ejected to the adjacent region, then the printer-side controller will, at a minimum, eject more ink than the amount of ink that is ejected during borderless printing so as to soak the surface of the sponge 246. By doing this, the surface area of the ink with respect to the ink amount becomes small, the sponge surface becomes less prone to drying even if cyan ink is used, and the pigment component of the ink that lands when borderless printing is performed permeates down into the sponge 246 and makes it harder for the pigment component to remain on the sponge surface. It should be noted that in light of the object to make the sponge less prone to dry, a “large ink amount” means a large ink amount per unit time and unit area.

It should be noted that the type of ink that is actively ejected to the adjacent region is not limited to the type of ink that is ejected according to the image to be printed. For example, even in cases where only color ink except for black ink is ejected in correspondence with the image to be printed, it is possible for black ink to be ejected to the adjacent region.

===(2) Other Implementations of the Second Embodiment===

<(2) Regarding the Ejection Timing of the Light Cyan Ink>

In the printing methods discussed above, light cyan ink is ejected to the adjacent region before and after the dot formation process. This is not a limitation, however. For example, it is also possible to eject light cyan ink to the adjacent region after the paper has been printed or during or after the paper discharge process.

In the above embodiment, the paper that is printed is cut paper (single sheet paper) such as A4 paper. However, the paper is not limited to cut paper, and can also be roll paper (continuous paper).

If printing is to be carried out with respect to roll paper, then the printer forms the print image on the cut paper, cuts that section, and then waits until the next printing operation. For this reason, a portion of the roll paper is located in the print region during this standby state (in the case of cut paper, there is no paper in the print region once printing has finished).

In the case of an embodiment where light cyan ink is directly applied to the ejection spillover region, the roll paper is present in the print region and thus the roll paper will become dirty if light cyan ink is ejected during this standby period. On the other hand, in the case of an embodiment in which light cyan ink is ejected to an adjacent region that is adjacent to and outside of the ejection spillover region, the light cyan ink can be ejected during this standby state (ejected in a state where the paper is present in the print region) without dirtying the paper. Thus, an embodiment in which light cyan ink is ejected to the adjacent region after printing has finished is particularly advantageous in the case of roll paper.

<(2) Regarding Borderless Printing>

In this embodiment, a case in which printing is performed so that no margin is left at the lateral end portions of the paper S was described as an example of borderless printing. However, because there is also an ejection spillover region when printing so that no margins are left at the upper and lower end portions of the paper S, it is also possible to eject light cyan ink (or light magenta ink) to the adjacent region that is adjacent to and outside of this region. The following is a description of borderless printing of the upper end portion of the paper S (borderless printing of the lower end portion is substantially the same as borderless printing of the upper end portion, and thus description thereof is omitted).

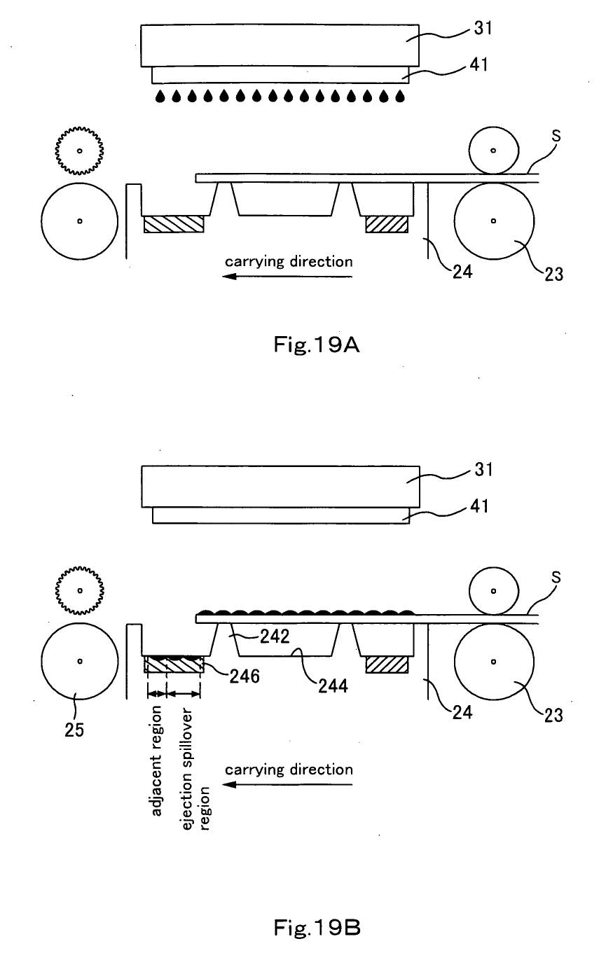

FIG. 19A is an explanatory diagram of how ink is ejected when performing borderless printing on the upper end portion of the paper. FIG. 19B is an explanatory diagram of how ink lands when performing borderless printing on the upper end portion of the paper.

When performing borderless printing on the upper end portion of the paper, ink is also ejected from nozzles that are not in opposition to the paper S, such that ink is ejected over a range that is wider than the paper S. For this reason, the ink that is ejected from nozzles that are not in opposition to the paper S (the nozzles on the carrying direction downstream side in the drawings) does not land on the paper S and instead lands on the sponge 246 of the groove section 244 (this region in which ink lands becomes the ejection spillover region).

Accordingly, it is also possible to print the upper end using, for example, nozzles upstream of nozzle #2 in the carrying direction and to eject light cyan ink from nozzle #1, thereby ejecting light cyan ink to the adjacent region that is adjacent to and outside of the ejection spillover region (i.e., on the carrying direction downstream side of the ejection spillover region). Thus, ink can be prevented from building up in the ejection spillover region when performing borderless printing on the upper end portion of the paper.

However, the amount of ejection spillover ink when performing borderless printing on the upper end portion of the paper is less than the amount of ejection spillover ink when performing borderless printing on the lateral end portions of the paper. Thus, it is also possible to eject light cyan ink to the adjacent region that is adjacent only to the ejection spillover region of the lateral end portions of the paper and to not eject light cyan ink to the adjacent region of the ejection spillover region of the upper and lower end portions of the paper.

### Other Embodiments

The foregoing embodiments are for the purpose of facilitating understanding of the present invention, and are not to be interpreted as limiting the present invention. The invention can of course be altered and improved without departing from the gist thereof, and includes equivalents. In particular, the embodiments mentioned below also are within the scope of the invention.

<Regarding the Head>

In the foregoing embodiments, ink is ejected using piezoelectric elements. However, the method for ejecting liquid is not limited to this. For example, it is also possible to employ other methods such as generating bubbles within the nozzles through heat.

Also, in the foregoing embodiments, the head is provided in the carriage. However, it is also possible to provide the head in an ink cartridge that can be attached and detached to and from the carriage.

===In Summary===

(1-1) The printer discussed above has a head 41 that ejects cyan ink (first pigment ink), which is a pigment ink that contains a moisturizing agent, and light cyan ink (second pigment ink), which is a pigment ink that contains more moisturizing agent than cyan ink.

When the printer executes borderless printing, there is ink that does not land on the paper, and there is a risk that the paper will become dirty if this ink adheres to the rear surface of the paper. Accordingly, the printer discussed above is provided with a groove section 244 in its platen 24 in order to receive the ink that is ejected from the head 41 during printing (in a state where the paper is present in the print region).

When a large amount of dark pigment ink lands in the groove section 244, the pigment component of the ink builds up in the groove section 244 and forms a mound of ink. When this mound of ink becomes higher than the support section 242, there is a risk that the rear surface of the paper will become dirty.

Accordingly, the printer-side controller 60 discussed above causes the head 41 to actively eject light cyan ink, which includes a large amount of moisturizing agent. As a result, the pigment component of the cyan ink is less likely to build up to form high mounds of ink, and thus the rear surface of the paper can be kept from becoming dirty.

It should be noted that when light cyan ink is ejected in a state where paper is present in the print region, there is a risk that the light cyan ink willl and on the paper. Accordingly, the printer-side controller 60 discussed above causes the ejection of light cyan ink in a state where paper is not present in the print region.

(1-2) The groove section 244 discussed above is provided with a sponge 246 that serves as an absorbing member. In particular, the sponge 246 is provided where the groove section 244 will function as the ejection spillover region.

The sponge 246 is a material that has excellent porosity and absorptivity, but when the mesh of fibers of the sponge surface is filled up by pigment, the sponge 246 loses its ability to function as an absorbing member and it becomes easier for a mound of ink to form on the sponge. Accordingly, the printer-side controller discussed above causes the head 41 to actively eject light cyan ink toward the sponge 246.

In the first embodiment discussed above, the sponge 246 is provided in the ejection spillover region of the groove section 244. However, it goes without saying that the absorbing member is not limited to sponge. It is also possible for there to not be an absorbing member in the ejection spillover region. In this case, if light cyan ink is ejected to the ejection spillover region, the pigment component of the dark ink can be made to flow by the moisturizing agent and thereby break down mounds of ink that have formed.

(1-3) In the first embodiment discussed above, the groove section 244 receives the ink that does not land on the lateral end portions of the paper S when performing borderless printing on the lateral end portions of the paper S (see FIG. 8B). With the above printer, the ejection spillover region keeps the mound of ink from becoming high when performing borderless printing on the lateral end portions of the paper S.

(1-4) In the first embodiment discussed above, the groove section 244 receives the ink that does not land on the upper and lower end portions of the paper S when performing borderless printing on the upper and lower end portions of the paper S (see FIG. 14B). With the above printer, the ejection spillover region keeps the mound of ink from becoming high when performing borderless printing on the upper and lower end portions of the paper S.

(1-5) In printing method 1 of the first embodiment (see FIG. 11), the printer-side controller 60 causes the head 41 to eject light cyan ink to the groove section 244 before printing. That is to say, in printing method 1, the process of step S103 is performed before the dot formation process (S105). By doing this, the moisturizing agent can be applied to the groove section 244 in advance before ink lands in the ejection spillover region when performing borderless printing, and this allows the buildup of pigment to be prevented.

(1-6) In printing method 2 of the first embodiment (see FIG. 13), the printer-side controller 60 causes the head 41 to eject light cyan ink to the groove section 244 after printing. That is to say, in printing method 2, the process of step S208 is performed after the dot formation process (S202). The buildup of ink can be prevented even if light cyan ink is ejected after printing has finished, as long as the light cyan ink is actively ejected to the ejection spillover region before the ink of the groove section 244 dries.

(1-7) In the first embodiment, the process of actively ejecting light cyan ink to the ejection spillover region is omitted depending on the settings that have been made by the user (see S101 or S206). Thus, the amount of ink consumption can be reduced if the user so wishes.

(1-8) In the first embodiment, if borderless printing is not performed, then the process of actively ejecting light cyan ink to the ejection spillover region is omitted (see S102 or S207). This is because ink does not land in the groove section 244 if borderless printing is not performed, and therefore there is no risk that ink will build up. By doing this, wasteful consumption of ink can be curbed.

(1-9) The cyan ink and the light cyan ink discussed above both absorb red light. However, the cyan ink and the light cyan ink contain different amounts of pigment, that is, coloring agent, and thus the amount of red light that each absorbs is different. By using inks of different darkness, graininess in the print image can be improved.

It should be noted that because cyan ink is a darker ink than light cyan ink, it has a greater amount of pigment component. An increase in the amount of pigment also means that there is a greater amount of resin and more solid component. When the amount of the solid component increases, however, the amount of moisturizing agent is reduced in order to adjust the viscosity of the ink. In other words, cyan ink has less moisturizing agent than light cyan ink.

When cyan ink, which has little moisturizing agent, lands in the groove section 244, its pigment component easily builds up to form a mound of ink. On the other hand, when light cyan ink, which has a large amount of moisturizing agent, lands in the groove section 244, its pigment component does not build up, and instead there is the effect that the build up of pigment component is inhibited.

Accordingly, the light cyan ink, which is the lighter of the two inks having different darkness, is actively ejected to the groove section 244 to inhibit the formation of a mound of ink.

(1-10) If all of the features of the embodiments are present, then all of the foregoing effects can be attained, and this is preferable. However, it goes without saying that it is not absolutely necessary for all of these features to be present in order to attain the effect of inhibiting ink from piling up.

(1-11) It should be apparent that the foregoing embodiment includes the disclosure of printing methods in addition to the disclosure of printers.

(1-12) It should also be apparent that the foregoing embodiment includes the disclosure of printing systems in addition to the disclosure of printers.

(1-13) It should be noted that the type of ink that is actively ejected to the ejection spillover region before or after the dot formation process is not limited to an ink that contains a large amount of moisturizing agent. For example, it is also possible to eject cyan ink, which is darker than light cyan ink. Such a printing apparatus also can obtain the effect of inhibiting the build up of ink.

(1-14) However, when the ink lands in the ejection spillover region dispersed in the same way as in borderless printing, the buildup of pigment is accelerated rather than curtailed. Thus, if cyan ink is actively ejected, it is necessary for the printer-side controller to soak the surface of the sponge 246 by at least ejecting more ink than the amount of ink that is ejected when borderless printing is performed.

(1-15) It should be noted that it is also possible for the type of ink that is actively ejected to the ejection spillover region before or after the dot formation process (the type of ink that is ejected from the head in a state where the medium is not present in the print region) to be included in the ink that is ejected when borderless printing is performed (the type of ink that is ejected from the head in a state where a medium is present in the print region).

(1-16) There is no limitation to this, however, and it is also possible for the type of ink that is actively ejected to the ejection spillover region before or after the dot formation process to be different from the type of ink that is ejected when performing borderless printing. For example, if color ink other than black ink is the type of ink that is ejected when performing borderless printing, then it is possible for black ink to be actively ejected to the ejection spillover region.

(1-17) It should be noted that with a printing method with which ink is actively ejected to the ejection spillover region, clearly it is possible to attain the effect of inhibiting the buildup of ink.

(1-18) Further, with a printing system with which ink is actively ejected to the ejection spillover region, clearly it is possible to attain the effect of inhibiting the buildup of ink.

(2-1) The printer discussed above has a head 41 that ejects cyan ink (first pigment ink), which is a pigment ink that contains a moisturizing agent, and light cyan ink (second pigment ink), which is a pigment ink that contains more moisturizing agent than cyan ink.

When the printer executes borderless printing, there is ink that does not land on the paper, and there is a risk that the paper will become dirty if this ink adheres to the rear surface of the paper. Accordingly, the printer discussed above is provided with a groove section 244 in its platen 24 in order to receive this ink that is ejected from the head 41 during printing (i.e., in a state where the paper is present in the print region).

When a large amount of dark pigment ink lands in the groove section 244, the pigment component of the ink builds up in the groove section 244 and forms a mound of ink. When this mound of ink becomes higher than the support section 242, there is a risk that the rear surface of the paper will become dirty.

Accordingly, the printer-side controller 60 discussed above causes the head 41 to actively eject light cyan ink, which contains a large amount of moisturizing agent. As a result, the pigment component of the cyan ink is less likely to build up to form high mounds of ink, and thus the rear surface of the paper can be kept from becoming dirty.

However, there is a risk that the light cyan ink will land on the paper if it is ejected to the ejection spillover region in a state where paper is present in the print region. Accordingly, the above printer-side controller 60 causes light cyan ink to be ejected to an adjacent region that is adjacent to and outside of the ejection spillover region.

(2-2) The groove section 244 discussed above is provided with a sponge 246 that serves as an absorbing member. In particular, the sponge 246 is provided where the groove section 244 will function as the ejection spillover region and the adjacent region.

The sponge 246 is a material that has excellent porosity and absorptivity, but when the mesh of fibers of the sponge surface becomes filled with pigment, the sponge 246 loses its ability to function as an absorbing member and it becomes easier for a mound of ink to form on the sponge. Accordingly, the printer-side controller discussed above causes the head 41 to actively eject light cyan ink toward the sponge 246.

In the second embodiment, the sponge 246 is provided in the ejection spillover region of the groove section 244. However, it goes without saying that the absorbing member is not limited to sponge. It is also possible for there to not be an absorbing member in the ejection spillover region or the adjacent region. In this case, if light cyan ink is ejected to the adjacent region, the pigment component of the dark ink can be made to flow by the moisturizing agent and thereby break down mounds of ink that have formed.

(2-3) In the second embodiment, the moisturizing agent of the light cyan ink that has been ejected to the adjacent region permeates down beneath the ejection spillover region. Due to this, the pigment component of the cyan ink that lands in the ejection spillover region can permeate down into the sponge 246, and the buildup of ink can thus be inhibited.

(2-4) In the second embodiment, the ejection spillover region and the adjacent region are separated from one another by the spacing of a pixel. For example, if 720 dpi is the spacing between pixels corresponding to the pixel data of FIG. 18B, then the ejection spillover region and the adjacent region will be separated by a spacing of 720 dpi.

(2-5) However, it is not absolutely necessary that the ejection spillover region and the adjacent region are separated from one another, and it is also possible for them to partially overlap. Doing this allows the pigment component of the ink that lands in the ejection spillover region to permeate further down into the interior of the sponge 246.

However, doing this increases the overall amount of ink that is ejected to the sponge 246.

(2-6) In the second embodiment discussed above, the groove section 244 receives the ink that does not land on the lateral end portions of the paper S during borderless printing of the lateral end portions of the paper S (see FIG. 8B). With the above printer, the ejection spillover region keeps the mound of ink from becoming high when performing borderless printing on the lateral end portions of the paper S.

(2-7) In the second embodiment discussed above, the groove section 244 receives the ink that does not land on the upper and lower end portions of the paper S during borderless printing of the upper and lower ends of the paper S (see FIG. 19B). With the above printer, the ejection spillover region keeps the mound of ink from becoming high when performing borderless printing on the upper and lower end portions of the paper S.

(2-8) The head 41 described above can move in the movement direction of the carriage 31. Also, in the second embodiment, the printer-side controller 60 causes the head 41 to eject light cyan ink to the adjacent region after the head 41 has started moving (step S304) but before the dot formation process of ejecting ink according to the image to be printed (step S306). Thus, the moisturizing agent can be applied to the groove section 244 in advance before ink lands in the ejection spillover region during the dot formation process, and this allows the buildup of pigment to be prevented.

(2-9) In the second embodiment, the printer-side controller 60 causes the head 41 to eject light cyan ink to the adjacent region after the dot formation process (step S306) but before movement of the head 41 is stopped (step S308). Thus, the moisturizing agent can be applied to the groove section 244 immediately after ink has landed in the ejection spillover region in the dot formation process, and this allows the buildup of pigment to be prevented.

(2-10) In the second embodiment discussed above, the process of actively ejecting light cyan ink to the adjacent region is omitted depending on the settings that have been made by the user. Thus, the amount of ink consumption can be reduced if the user so wishes.

(2-11) In the second embodiment discussed above, if borderless printing is not performed, then the process of actively ejecting light cyan ink to the adjacent region is omitted. This is because ink does not land in the groove section 244 if borderless printing is not performed, and therefore there is no risk that ink will build up. By doing this, unnecessary consumption of ink can be curbed.

(2-12) The cyan ink and the light cyan ink discussed above both absorb red light. However, the cyan ink and the light cyan ink contain different amounts of pigment, that is, coloring agent, and thus the amount of red light that each absorbs is different. By using inks of different darkness; graininess in the print image can be improved.

It should be noted that because cyan ink is a darker ink than light cyan ink, it has more pigment. An increase in the amount of pigment also means that there is a greater amount of resin and more solid component. When the amount of the solid component increases, however, the amount of moisturizing agent is reduced in order to adjust the viscosity of the ink. In other words, cyan ink has less moisturizing agent than light cyan ink.

When cyan ink, which has little moisturizing agent, lands in the groove section 244, its pigment component easily builds up to form a mound of ink. On the other hand, when light cyan ink, which has a large amount of moisturizing agent, lands in the groove section 244, its pigment component does not build up, and instead there is the effect of inhibiting build-up of pigment components.

Accordingly, the light cyan ink, which is the lighter of the two inks having different darkness, is actively ejected to the groove section 244 to inhibit the formation of a mound of ink.

(2-13) It should be noted that a printer that includes all of the configuration aspects already discussed can achieve all of the effects, and thus is advantageous.

(2-14) The dot formation step (step S306) of the printing methods described above is a step of ejecting cyan ink and light cyan ink, which has more moisturizing agent than cyan ink, in accordance with the image to be printed in a state where the paper (medium) is present in the print region. After ink has been ejected from the head (FIG. 8A), the ink that does not land on the paper is received by the groove section (FIG. 8B). Then, step S305 or step S307 of the printing methods are steps in which light cyan ink is ejected to the adjacent region that is adjacent to and outside of the ejection spillover region in a state where the paper is present in the print region.

The above printing methods having these steps allow the pigment component of the ink that lands in the ejection spillover region to permeate more readily into the sponge and thereby discourages buildup of the pigment component.

(2-15) The printing system 100 has the main computer unit 110 and the printer 1. With this printing system, if light cyan ink is ejected to the adjacent region that is adjacent to and outside of the ejection spillover region, then the pigment component of the ink that lands in the ejection spillover region easily permeates into the sponge, making the deposition of pigment less likely to occur.

It should be noted that the addition of data for moisturization (FIG. 18B) to the print data can be performed by the printer driver (performed on the main computer unit side) or can be performed on the printer side.

(2-16) It should be noted that the type of ink that is ejected to the adjacent region is not limited to an ink that contains a large amount of moisturizing agent. For example, it is also possible to eject cyan ink, which is darker than light cyan ink. Such a printing apparatus also can obtain the effect of inhibiting the build up of ink.

(2-17) However, when the cyan ink lands in the adjacent region dispersed in the same way as in borderless printing, the build up of pigment is accelerated rather than curtailed. Thus, in a case where cyan ink is ejected to the adjacent region, it is necessary for the printer-side controller to soak the surface of the sponge 246 by at least causing the ejection of more ink than the amount of ink that is ejected when borderless printing is performed.

(2-18) It should be noted that it is also possible for the type of ink that is ejected to the adjacent region to be the same as the type of ink that is ejected according to the image to be printed.

(2-19) There is no limitation to this, however, and it is also possible for the type of ink that is ejected to the adjacent region to be different from the type of ink that is ejected according to the image to be printed. For example, if color ink other than black ink is the type of ink that is ejected according to the image to be printed, then it is also possible for black ink to be ejected to the adjacent region.

(2-20) It should be noted that with a printing method with which ink is actively ejected to the adjacent region, clearly it is possible to attain the effect of inhibiting the buildup of ink.

(2-21) Further, with a printing system with which ejection is actively performed with respect to the adjacent region, clearly it is possible to attain the effect of inhibiting the buildup of ink.

What is claimed is:

1. A printing method comprising the steps of:
when a first pigment ink that contains a moisturizing agent and a second pigment ink that contains more moisturizing agent than said first pigment ink have been ejected from a head in a state where a medium is present in a print region, receiving in a receiving section said first pigment ink and said second pigment ink that do not land on said medium; and
causing said head to eject said second pigment ink to said receiving section in a state where said medium is not present in said print region.

2. A printing method according to claim 1,
wherein said receiving section has an absorbing member that absorbs said first pigment ink and said second pigment ink.

3. A printing method according to claim 1,
wherein said receiving section receives said first pigment ink and said second pigment ink that do not land on a lateral end portion of said medium.

4. A printing method according to claim 1,
wherein said receiving section receives said first pigment ink and said second pigment ink that do not land on upper and lower end portions of said medium.

5. A printing method according to claim 1,
wherein by causing said head to eject said second pigment ink to said receiving section before printing on said medium, said head is caused to eject said second pigment ink to said receiving section in a state where said medium is not present in said print region.

6. A printing method according to claim 1,
wherein by causing said head to eject said second pigment ink to said receiving section after printing on said medium, said head is caused to eject said second pigment ink to said receiving section in a state where said medium is not present in said print region.

7. A printing method according to claim 1,
wherein whether or not to cause said head to eject said second pigment ink to said receiving section in a state where the medium is not present in said print region is determined based on a setting that has been made by a user.

8. A printing method according to claim 1,
wherein in a case where printing is not to be performed on an end portion of said medium, said head is not caused to eject said second pigment ink to said receiving section in a state where the medium is not present in said print region.

9. A printing method according to claim 1,
wherein said first pigment ink and said second pigment ink both absorb light of a same wavelength, but absorb different amounts of said light.

10. A printing method comprising the steps of:
when a first pigment ink that contains a moisturizing agent and a second pigment ink that contains more moisturizing agent than said first pigment ink have been ejected from a head in a state where a medium is present in a print region, receiving in a receiving section said first pigment ink and said second pigment ink that do not land on said medium; and
causing said head to eject said second pigment ink to said receiving section in a state where said medium is not present in said print region;
wherein said receiving section has an absorbing member that absorbs said first pigment ink and said second pigment ink;
wherein said receiving section receives said first pigment ink and said second pigment ink that do not land on a lateral end portion of said medium;
wherein said receiving section receives said first pigment ink and said second pigment ink that do not land on upper and lower end portions of said medium;
wherein by causing said head to eject said second pigment ink to said receiving section before printing on said medium, said head is caused to eject said second pigment ink to said receiving section in a state where said medium is not present in said print region;
wherein whether or not to cause said head to eject said second pigment ink to said receiving section in a state where the medium is not present in said print region is determined based on a setting that has been made by a user;
wherein in a case where printing is not to be performed on an end portion of said medium, said head is not caused to eject said second pigment ink to said receiving section in a state where the medium is not present in said print region; and
wherein said first pigment ink and said second pigment ink both absorb light of a same wavelength, but absorb different amounts of said light.

11. A printing apparatus comprising:
a head that ejects a first pigment ink that contains a moisturizing agent and a second pigment ink that contains more moisturizing agent than said first pigment ink;
a receiving section that receives said first pigment ink and said second pigment ink that do not land on a medium when said first pigment ink and said second pigment ink have been ejected from said head in a state where said medium is present in a print region; and
a controller that causes said head to eject said second pigment ink to said receiving section in a state where the medium is not present in said print region.

12. A printing system comprising:
a computer; and
a printing apparatus that is connected to said computer, said printing apparatus having:
a head that ejects a first pigment ink that contains a moisturizing agent and a second pigment ink that contains more moisturizing agent than said first pigment ink;
a receiving section that receives said first pigment ink and said second pigment ink that do not land on a medium when said first pigment ink and said second pigment ink have been ejected from said head in a state where said medium is present in a print region; and
a controller that causes said head to eject said second pigment ink to said receiving section in a state where the medium is not present in said print region.

13. A printing method comprising the steps of:
receiving in a receiving section a pigment ink that does not land on a medium when said pigment ink has been ejected from a head in a state where said medium is present in a print region; and
causing said head to eject a pigment ink to said receiving section in a state where said medium is not present in said print region.

14. A printing method according to claim 13,
wherein an amount of said pigment ink that is ejected from said head to said receiving section in a state where said medium is not present in said print region is greater than an amount of said pigment ink that is ejected from said head to said receiving section in a state where said medium is present in said print region.

15. A printing method according to claim 13,
wherein a type of said pigment ink that is ejected from said head to said receiving section in a state where said medium is not present in said print region is included in the types of said pigment ink that are ejected from said head to said receiving section in a state where said medium is present in said print region.

16. A printing method according to claim 13,
wherein a type of said pigment ink that is ejected from said head to said receiving section in a state where said medium is not present in said print region is different from a type of said pigment ink that is ejected from said head to said receiving section in a state where said medium is present in said print region.

17. A printing apparatus comprising:
a head that ejects pigment ink;
a receiving section that receives said pigment ink that does not land on a medium when said pigment ink is ejected from said head in a state where said medium is present in a print region; and
a controller that causes said head to eject said pigment ink to said receiving section in a state where the medium is not present in said print region.

18. A printing system comprising:
a computer; and
a printing apparatus that is connected to said computer, said printing apparatus having:
a head that ejects pigment ink;
a receiving section that receives said pigment ink that does not land on a medium when said pigment ink is ejected from said head in a state where said medium is present in a print region; and
a controller that causes said head to eject said pigment ink to said receiving section in a state where the medium is not present in said print region.

19. A printing method comprising the steps of:
ejecting, in a state where a medium is present in a print region, a first pigment ink that contains a moisturizing agent, and a second pigment ink that contains more moisturizing agent than said first pigment ink according to an image to be printed;
receiving in a receiving section said first pigment ink and said second pigment ink that do not land on said medium; and
ejecting, in a state where said medium is present in said print region, said second pigment ink to an adjacent region that is adjacent to and outside of a region where said receiving section receives said first pigment ink and said second pigment ink that have been ejected according to said image to be printed and that do not land on said medium.

20. A printing method according to claim 19,
wherein said receiving section has an absorbing member that absorbs said first pigment ink and said second pigment ink.

21. A printing method according to claim 20,
wherein the moisturizing agent of said second pigment ink that has been ejected to said adjacent region permeates beneath the region where said receiving section receives said first pigment ink and said second pigment ink that do not land on said medium.

22. A printing method according to claim 21,
wherein said adjacent region is separated from the region where said receiving section receives said first pigment ink and said second pigment ink that do not land on said medium.

23. A printing method according to claim 21,
wherein said adjacent region partially overlaps the region where said receiving section receives said first pigment ink and said second pigment ink that do not land on said medium.

24. A printing method according to claim 19,
wherein said receiving section receives said first pigment ink and said second pigment ink that do not land on a lateral end portion of said medium.

25. A printing method according to claim 19,
wherein said receiving section receives said first pigment ink and said second pigment ink that do not land on upper and lower end portions of said medium.

26. A printing method according to claim 19,
wherein said head can move in a predetermined direction; and
wherein said second pigment ink is ejected from said head to said adjacent region after movement of said head has started but before said head ejects, while moving, said first pigment ink and said second pigment ink according to said image to be printed.

27. A printing method according to claim 19,
wherein said head can move in a predetermined direction; and
wherein said second pigment ink is ejected from said head to said adjacent region after said head has ejected, while moving, said first pigment ink and said second pigment ink according to said image to be printed but before movement of said head is stopped.

28. A printing method according to claim 19,
wherein whether or not to cause an ejection of said second pigment ink to said adjacent region is determined based on a setting that has been made by a user.

29. A printing method according to claim 19,
wherein said controller does not cause an ejection of said second pigment ink to said adjacent region in a case where printing is not to be performed on an end portion of said medium.

30. A printing method according to claim 19,
wherein said first pigment ink and said second pigment ink both absorb light of a same wavelength, but absorb different amounts of said light.

31. A printing method comprising the steps of:
ejecting, in a state where a medium is present in a print region, a first pigment ink that contains a moisturizing agent, and a second pigment ink that contains more moisturizing agent than said first pigment ink according to an image to be printed;
receiving in a receiving section said first pigment ink and said second pigment ink that do not land on said medium; and
ejecting, in a state where said medium is present in said print region, said second pigment ink to an adjacent region that is adjacent to and outside of a region where said receiving section receives said first pigment ink and said second pigment ink that have been ejected according to said image to be printed and that do not land on said medium;
wherein said receiving section has an absorbing member that absorbs said first pigment ink and said second pigment ink;
wherein the moisturizing agent of said second pigment ink that has been ejected to said adjacent region permeates beneath the region where said receiving section receives said first pigment ink and said second pigment ink that do not land on said medium;
wherein said adjacent region is separated from the region where said receiving section receives said first pigment ink and said second pigment ink that do not land on said medium;
wherein said receiving section receives said first pigment ink and said second pigment ink that do not land on a lateral end portion of said medium;
wherein said receiving section receives said first pigment ink and said second pigment ink that do not land on upper and lower end portions of said medium;
wherein said head can move in a predetermined direction;
wherein said second pigment ink is ejected from said head to said adjacent region after movement of said head has started but before said head ejects, while moving, said first pigment ink and said second pigment ink according to said image to be printed;
wherein said second pigment ink is ejected from said head to said adjacent region after said head has ejected, while moving, said first pigment ink and said second pigment ink according to said image to be printed but before movement of said head is stopped;
wherein whether or not to cause an ejection of said second pigment ink to said adjacent region is determined based on a setting that has been made by a user;
wherein said controller does not cause an ejection of said second pigment ink to said adjacent region in a case where printing is not to be performed on the end portions of said medium; and
wherein said first pigment ink and said second pigment ink both absorb light of a same wavelength, but absorb different amounts of said light.

32. A printing apparatus comprising:
a head that ejects a first pigment ink that contains a moisturizing agent and a second pigment ink that contains more moisturizing agent than said first pigment ink;
a receiving section that, when said first pigment ink and said second pigment ink have been ejected from said head in a state where a medium is present in a print region, receives said first pigment ink and said second pigment ink that do not land on said medium; and
a controller that causes said head to eject, in a state where said medium is present in said print region, said second pigment ink to an adjacent region that is adjacent to and outside of a region where said receiving section receives said first pigment ink and said second pigment ink that have been ejected according to an image to be printed and that do not land on said medium.

33. A printing system comprising:
a computer; and
a printing apparatus that is connected to said computer, said printing apparatus having:
a head that ejects a first pigment ink that contains a moisturizing agent and a second pigment ink that contains more moisturizing agent than said first pigment ink;
a receiving section that, when said first pigment ink and said second pigment ink have been ejected from said head in a state where a medium is present in a print region, receives said first pigment ink and said second pigment ink that do not land on said medium; and
a controller that causes said head to eject, in a state where said medium is present in said print region, said second pigment ink to an adjacent region that is adjacent to and outside of a region where said receiving section receives said first pigment ink and said second pigment ink that have been ejected according to an image to be printed and that do not land on said medium.

34. A printing method comprising the steps of:
ejecting a pigment ink according to an image to be printed in a state where a medium is present in a print region;
receiving in a receiving section said pigment ink that does not land on said medium; and
ejecting, in a state where the medium is present in said print region, a pigment ink to an adjacent region that is adjacent to and outside of a region where said receiving section receives said pigment ink that has been ejected according to said image to be printed and that does not land on said medium.

35. A printing method according to claim 34,
wherein an amount of said pigment ink that is ejected to said adjacent region is greater than an amount of said pigment ink that is ejected to the region where said receiving section receives said pigment ink that has been ejected according to said image to be printed and that does not land on said medium.

36. A printing method according to claim 34,
wherein a type of said pigment ink that is ejected to said adjacent region is included in the types of said pigment ink that are ejected according to said image to be printed.

37. A printing method according to claim 34,
wherein a type of said pigment ink that is ejected to said adjacent region is different from a type of said pigment ink that is ejected according to said image to be printed.

38. A printing apparatus comprising:
a head that ejects a pigment ink;
a receiving section that receives said pigment ink that does not land on a medium when said pigment ink has been ejected from said head in a state where said medium is present in a print region; and
a controller that causes said head to eject, in a state where said medium is present in said print region, a pigment ink to an adjacent region that is adjacent to and outside of a region where said receiving section receives said pigment ink that has been ejected according to an image to be printed and that does not land on said medium.

39. A printing system comprising:
a computer; and
a printing apparatus that is connected to said computer, said printing apparatus having:
a head that ejects a pigment ink;
a receiving section that receives said pigment ink that does not land on a medium when said pigment ink has been ejected from said head in a state where said medium is present in a print region; and
a controller that causes said head to eject, in a state where said medium is present in said print region, a pigment ink to an adjacent region that is adjacent to and outside of a region where said receiving section receives said pigment ink that has been ejected according to an image to be printed and that does not land on said medium.
